(19) United States
(12) Patent Application Publication
(10) Pub. No.: US 2011/0102256 A1
(43) Pub. Date: May 5, 2011

(54) Positioning system, positioning method, and positioning program

(75) Inventors: Jiyun Shen, Tokyo (JP); Yasuhiro Oda, Tokyo (JP)

(73) Assignees: NTT DOCOMO, INC., Tokyo (JP); Polaris Wireless, Inc., Santa Clara, CA (US)

(21) Appl. No.: 12/898,052

(22) Filed: Oct. 5, 2010

(30) Foreign Application Priority Data
Nov. 2, 2009 (JP) P2009-252173

(51) Int. Cl. G01S 19/48

(52) U.S. Cl. 342/357.31

(57) ABSTRACT

It is possible to obtain the highly accurate positioning result even when positioning by a GPS is unsuccessful. A positioning server 10 includes a GVM database 12 storing information indicating a relationship between a position and whether or not signal reception from a GPS satellite 40 is possible in the position for each GPS satellite 40, a GPS information acquisition component 13 for acquiring reception GPS information indicating GPS satellites 40 from which the cellular terminal 20 has received signals, a candidate estimation component 14 for estimating candidates for the position of the cellular terminal 20 from the reception GPS information on the basis of the information stored in the GVM database 12, a reception state information acquisition component 15 for acquiring reception state information indicating a reception state of a radio wave from a cellular base station 30 in the cellular terminal 20, and a base station positioning calculation component 17 for estimating the position of the cellular terminal 20 from the candidates for the position of the cellular terminal 20 estimated by the candidate estimation component 14 and the reception state information.

### CROSS-REFERENCE TO RELATED APPLICATIONS

Japanese Patent application No. 2009-252173, filed on Nov. 2, 2009, is incorporated herein by reference.

### FIELD OF THE INVENTION

The present invention relates to a positioning system, a positioning method, and a positioning program for estimating a position of a receiver.

### BACKGROUND OF THE INVENTION

In the past, there has been proposed a technique for estimating a position of a receiver such as a cellular terminal (mobile communication terminal) on the basis of the reception strength (reception level) of a radio wave received by the receiver. In the Japanese patent document of Japanese Unexamined Patent Application Publication No. H7-231473 (Patent Document 1), a technique is disclosed for storing information indicating a relationship between the reception strength of a radio wave received from a given base station and the position at where the radio wave is received in a database, and estimating the position of the receiver matching the reception strength using the database.

Also, in the past, there has been known a technique for performing a positioning process for a receiver using a GPS (global positioning system) (see, for example, “Introduction to GPS Technology” by Takeyasu Isaka, Tokyo Denki University Publishing, Feb. 28, 2003 (Non-patent Document 1)). Also, there has been known an AGPS (assisted GPS) method of performing positioning using assist data indicating a satellite position or the like acquired from a mobile communication network.

When positioning by a GPS fails (that is, when the GPS positioning result is not fixed), base station positioning performs positioning by pattern matching as mentioned above using a signal of a mobile communication network, or hybrid positioning performs positioning with a combination of a signal from a GPS satellite and a signal of a mobile communication network.

### SUMMARY OF THE INVENTION

However, since a receiver is in a state in which a signal from a GPS satellite may not be received with high sensitivity such as a state in which the receiver is located indoors when positioning by a GPS is unsuccessful, a signal of the mobile communication network may also not be received with high sensitivity in such a case. Accordingly, positioning accuracy using a signal of a mobile communication network is not usually sufficient.

The present invention has been conceived in view of the above situations, and an object of the invention is to provide a positioning system, a positioning method, and a positioning program capable of obtaining a highly accurate positioning result even in the case where positioning by a GPS is unsuccessful.

According to the invention for accomplishing the above-described object, there is provided a positioning system for estimating a position of a receiver having a wireless communication function and a function of receiving signals to be used for GPS positioning, including: a database storing information indicating a relationship between a position and whether or not signal reception from a GPS satellite is possible in the position for each GPS satellite; a reception GPS information acquisition unit for acquiring reception GPS information indicating GPS satellites from which the receiver has received signals; a candidate estimation unit for estimating candidates for the position of the receiver from the reception GPS information acquired by the reception GPS information acquisition unit on the basis of the information stored in the database; a reception state information acquisition unit for acquiring reception state information indicating a reception state of a radio wave by the wireless communication function in the receiver; and a position estimation unit for estimating the position of the receiver from the candidates for the position of the receiver estimated by the candidate estimation unit and the reception state information acquired by the reception state information acquisition unit.

The positioning system according to the invention estimates the position of the receiver after estimating the candidate for the position of the receiver on the basis of not only the reception state of the radio wave by the wireless communication function, but also whether or not the signal reception from the GPS satellite is possible. Accordingly, it is possible to obtain the highly accurate positioning result even when the position of the receiver is estimated from the reception state in a state in which positioning by a GPS is unsuccessful.

Preferably, the database stores information indicating a relationship between a position and whether or not signal reception from a GPS satellite is possible in the position for each GPS satellite at each time, the reception GPS information acquisition unit acquires the reception GPS information and time information indicating a time when the signals have been received, and the candidate estimation unit estimates the candidates for the position of the receiver from the reception GPS information acquired by the reception GPS information acquisition unit on the basis of information stored in the database and corresponding to the time indicated by the time information acquired by the reception GPS information acquisition unit. According to this configuration, it is possible to appropriately estimate the candidate for the position of the receiver at an arbitrary time and consequently it is possible to obtain a highly accurate positioning result at an arbitrary time.

Preferably, the positioning system according to the invention further includes an indoor/outdoor determination unit for determining whether the receiver is located indoors or outdoors on the basis of the reception state information acquired by the reception state information acquisition unit, wherein the position estimation unit estimates the position of the receiver from the candidates for the position of the receiver estimated by the candidate estimation unit and the reception state information acquired by the reception state information acquisition unit depending on the determination result by the indoor/outdoor determination unit. According to this configuration, for example, it is possible to obtain a highly accurate positioning result based on a reception state without having to actually perform the GPS positioning when the receiver is located indoors, that is, when the possibility of a positioning failure by the GPS positioning is high.

Preferably, the position estimation unit estimates the position of the receiver by the GPS positioning based on the signals received by the receiver and used for the GPS positioning, and estimates the position of the receiver from the candidates for the position of the receiver estimated by the candidate estimation unit and the reception state information acquired by the reception state information acquisition unit when the position of the receiver has not been estimated by the GPS positioning. According to this configuration, it is possible to reliably obtain a highly accurate positioning result based on the reception state even when GPS positioning has actually failed.

Preferably, the candidate estimation unit decides the GPS satellites related to the reception GPS information to be used for estimating the candidates for the position of the receiver on the basis of the quality of reception of the signals from the GPS satellite. According to this configuration, it is possible to more appropriately estimate the candidates for the position of the receiver and consequently it is possible to obtain a more highly accurate positioning result.

Preferably, the reception state information acquisition unit acquires strength information indicating reception strength corresponding to a transmission source of the radio wave as the reception state information, and the position estimation unit stores in advance information indicating a relationship between the reception strength of the radio wave corresponding to the transmission source of the radio wave and the position, compares the pre-stored information to the strength information acquired by the reception state information acquisition unit, and estimates the position of the receiver from the comparison result and the candidates for the position of the receiver estimated by the candidate estimation unit. According to this configuration, it is possible to reliably obtain the highly accurate positioning result based on the reception state.

Preferably, the position estimation unit calculates a distance between the transmission source of the radio wave and the receiver on the basis of the reception state information, and estimates the position of the receiver from the distance and the candidates for the position of the receiver estimated by the candidate estimation unit. According to this configuration, it is possible to reliably obtain a highly accurate positioning result based on the reception state.

The present invention not only can be described as an invention of the positioning system as described above, but also can be described as inventions of a positioning method and a positioning program as follows. These inventions have only different categories, and are substantially the same invention having the same operation and advantageous effect.

That is, according to the invention, there is provided a positioning method for use in a positioning system for estimating a position of a receiver having a wireless communication function and a function of receiving signals to be used for GPS positioning, wherein the positioning system has a database storing information indicating a relationship between a position and whether or not signal reception from a GPS satellite is possible in the position for each GPS satellite, the positioning method including; a reception GPS information acquisition step of acquiring reception GPS information indicating GPS satellites from which the receiver has received signals; a candidate estimation step of estimating candidates for the position of the receiver from the reception GPS information acquired in the reception GPS information acquisition step on the basis of the information stored in the database; a reception state information acquisition step of acquiring reception state information indicating a reception state of a radio wave by the wireless communication function in the receiver; and a position estimation step of estimating the position of the receiver from the candidates for the position of the receiver estimated in the candidate estimation step and the reception state information acquired in the reception state information acquisition step.

According to the invention, there is provided a positioning program for causing a computer to estimate a position of a receiver having a wireless communication function and a function of receiving signals to be used for GPS positioning, the positioning program causing the computer to execute: a database function of storing information indicating a relationship between a position and whether or not signal reception from a GPS satellite is possible in the position for each GPS satellite; a reception GPS information acquisition function of acquiring reception GPS information indicating GPS satellites from which the receiver has received signals; a candidate estimation function of estimating candidates for the position of the receiver from the reception GPS information acquired by the reception GPS information acquisition function on the basis of the information stored in the database; a reception state information acquisition function of acquiring reception state information indicating a reception state of a radio wave by the wireless communication function in the receiver; and a position estimation function of estimating the position of the receiver from the candidates for the position of the receiver estimated by the candidate estimation function and the reception state information acquired by the reception state information acquisition function.

According to the invention, it is possible to obtain a highly accurate positioning result even when a position of the receiver is estimated from the reception state in a state in which positioning by a GPS is unsuccessful since the position of the receiver is estimated after candidates for the position of the receiver are estimated on the basis of not only a reception state of a radio wave by a wireless communication function, but also whether or not signal reception from a GPS satellite is possible.

### BRIEF DESCRIPTION OF THE DRAWINGS

FIG. 1 is a diagram showing the functional configuration of a cellular terminal as a receiver and a positioning server constituting a positioning system according to an embodiment of the present invention;

FIG. 2 is a diagram schematically showing a method for specifying candidates for a position of a cellular terminal 20 on the basis of a signal used for GPS positioning;

FIG. 3 is a diagram showing the hardware configuration of the cellular terminal as the receiver according to an embodiment of the present invention;

FIG. 4 is a diagram showing GVMs stored in a GVM database;

FIG. 5 is a flowchart showing a GVM creation method;

FIG. 6 is a table showing time bands in which a signal can be received from each GPS satellite;

FIG. 7 is a diagram illustrating the estimation of candidates for the position of the cellular terminal using the GVMs;

FIG. 8 is a diagram showing the functional configuration of an indoor/outdoor determination component;

FIG. 9 is a table showing an example of information stored in a determination database;

FIG. 10 is a diagram illustrating a method for estimating a position of the cellular terminal from candidates for the position of the cellular terminal estimated using the GVMs and pattern matching positioning;

FIG. 11 is a diagram illustrating a method for estimating a position of the cellular terminal from candidates for the position of the cellular terminal estimated using the GVMs and RTT positioning;

FIG. 12 is a diagram showing the hardware configuration of the positioning server according to an embodiment of the present invention;

FIG. 13 is a flowchart showing an indoor/outdoor determination process (indoor/outdoor determination method);

FIG. 14 is a diagram showing the process of FIG. 13;

FIG. 15 is diagrams illustrating the construction of a determination database;

FIG. 16 is a flowchart showing a process (positioning method) to be executed by the cellular terminal as the receiver and the positioning server constituting the positioning system according to an embodiment of the present invention;

FIG. 17 is a flowchart showing a process of estimating candidates for the position of the cellular terminal using the GVMs;

FIG. 18 is a flowchart showing another example of the process (positioning method) to be executed by the cellular terminal as the receiver and the positioning server constituting the positioning system according to an embodiment of the present invention;

FIG. 19 is a diagram showing the configuration of a positioning program according to an embodiment of the present invention;

FIG. 20 is a flowchart showing a first modified example of the indoor/outdoor determination process (indoor/outdoor determination method);

FIG. 21 is a diagram showing the functional configuration of a second modified example of the indoor/outdoor determination component; and

FIG. 22 is a flowchart showing a second modified example of the indoor/outdoor determination process (indoor/outdoor determination method).

### DESCRIPTION OF THE PREFERRED EMBODIMENTS

Preferred embodiments of a positioning system, a positioning method, and a positioning program according to the present invention will now be described in detail along with the drawings. The same elements in the drawings are denoted by the same reference numerals, and redundant description is omitted.

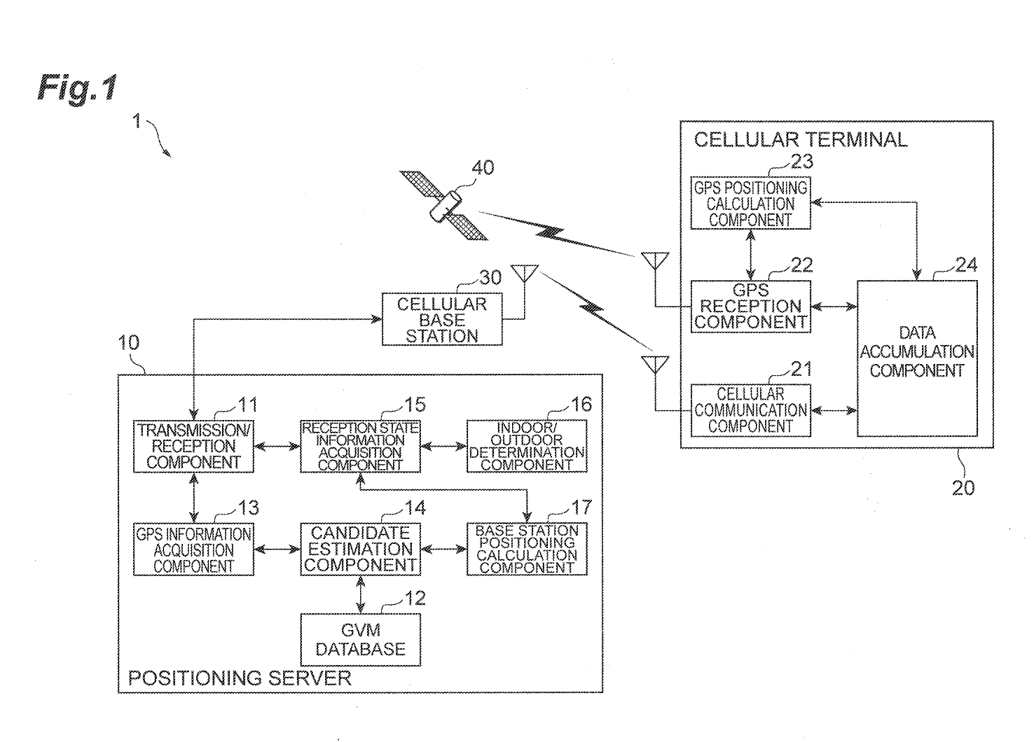

FIG. 1 shows a positioning system 1 according to this embodiment. The positioning system includes a positioning server 10 and a cellular terminal (mobile communication terminal) 20 which is a receiver according to this embodiment, and is a system for estimating a position of the cellular terminal 20. The positioning server 10 is a device for estimating the position of the cellular terminal 20 (performing a comprehensive estimation process). The (control of) positioning for the cellular terminal 20 by the positioning server 10 is performed using only the framework of a cellular communication system (mobile communication system). The positioning server 10 is connected with a plurality of cellular base stations 30 included in the cellular communication system, and can transmit and receive information to and from each of the cellular base stations 30. Communication with the cellular terminal 20 can also be performed via the cellular base stations 30. The positioning server 10 may also be included in a cellular communication system (mobile communication system). As described later, the cellular terminal 20 has a function of receiving signals to be used for GPS positioning, and positioning for the cellular terminal 20 by the positioning server 10 is also performed using the function.

Here, a method in which the function of receiving signals to be used for GPS positioning is used for positioning is schematically illustrated in the present invention. When a signal from the GPS satellite is interrupted between the GPS satellite and the cellular terminal 20 as in the case where the cellular terminal 20 is located indoors, the cellular terminal 20 may not receive a signal from the GPS satellite. On the other hand, even when the cellular terminal 20 is located indoors, a signal from the GPS satellite may be received depending on the position of a building or a window installed in a building. Thereby, a GPS satellite from which a signal may be received and a GPS satellite from which no signal may be received correspond to the position of the cellular terminal 20. The present invention is aimed at specifying candidates for the position of the cellular terminal 20 using the above-described characteristics even when GPS positioning may not be performed by signal reception from GPS satellites (for example, when signals from a sufficient number of GPS satellites may not be received to perform GPS positioning).

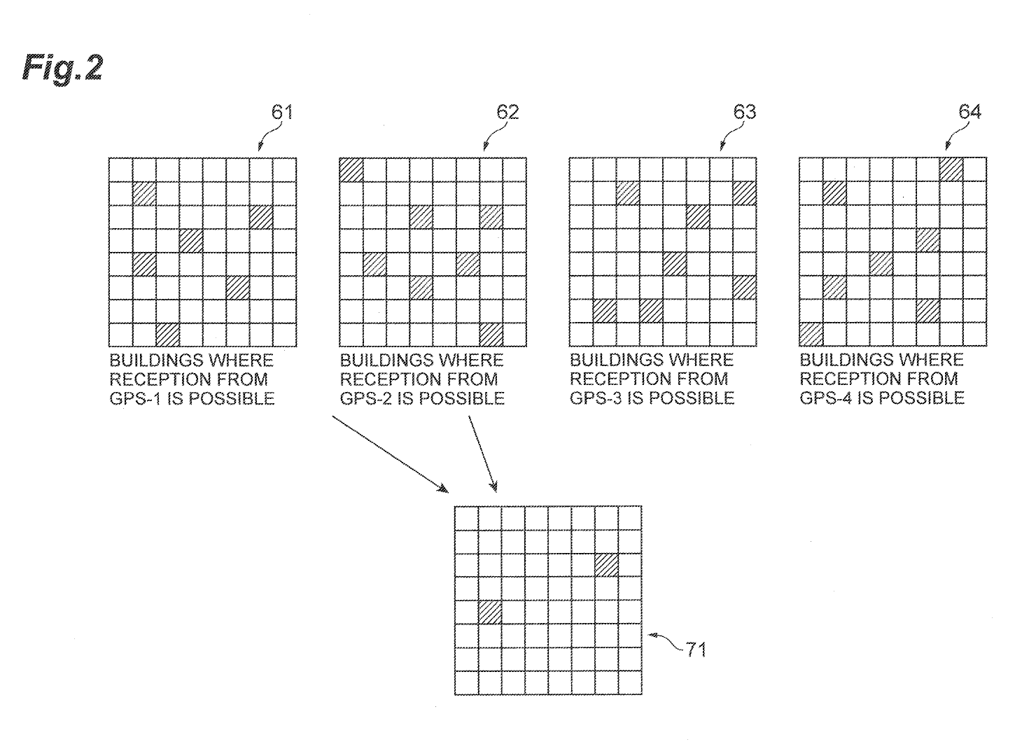

Thus, in the present invention, information indicating the relationship between the position of the cellular terminal 20 and whether or not the cellular terminal 20 can receive signals from the GPS satellites in the position is pre-stored. In this embodiment, this information is referred to as a GVM (GPS Visibility Mask). As shown in FIG. 2, GVMs 61, 62, 63, and 64 are information of GPS satellite-specific. In the example of FIG. 2, the GVMs are provided for four satellites whose GPS numbers are “GPS-1,” “GPS-2,” “GPS-3,” and “GPS-4.” For example, the GVM is divided into meshes of positioning target areas. Each mesh is associated with information indicating the availability of signal reception from the GPS satellite. In the example of FIG. 2, a hatched mesh indicates that a signal can be received from the GPS satellite, and a non-hatched mesh indicates that no signal can be received from the GPS satellite. It is desirable to set the above-described mesh to have a size in which GPS satellite from which a signal can be received and GPS satellite from which no signal can be received are same, as a size in which a building can be identified. The GVM may not be necessarily divided into the meshes. For example, the GVM may be information indicating whether or not a signal can be received from a GPS satellite in each position (point).

Candidates for the position of the cellular terminal 20 are specified as follows. First, information indicating GPS satellites from which signals have been received by the cellular terminal 20 is acquired. A mesh in which a signal can be received from a GPS satellite in GVMs related to all these GPS satellites is commonly set as a candidate for the position of the cellular terminal 20. When signals of the GPS satellite of “GPS-1” and the GPS satellite of “GPS-2” have been received in the example of FIG. 2, two meshes (reference numeral 71 of the lower portion of FIG. 2) in which signals can be commonly received from GPS satellites in GVMs 61 and 62 are determined to be candidates for the position of the cellular terminal 20. The above is an outline of the method in which the function of receiving signals to be used for GPS positioning is used for positioning in the present invention.

The cellular terminal 20 as a positioning target will be described before the positioning server 10 according to this embodiment is described in detail. The cellular terminal 20 is a device having a wireless communication function and a function of receiving signals to be used for GPS positioning. The cellular terminal 20 also has a function of performing a GPS positioning calculation. More specifically, the cellular terminal 20 is constituted by including a cellular communication component 21, a GPS reception component 22, a GPS positioning calculation component 23, and a data accumulation component 24 as shown in FIG. 1.

The cellular communication component 21 is a unit for performing cellular communication (mobile communication) by wireless communication between the plurality of cellular base stations 30 included in the cellular communication network (mobile communication network) of the cellular communication system. The cellular communication component 21 is provided with an antenna for cellular communication. The antenna is used to perform cellular communication. The cellular communication component 21 performs ordinary cellular communication such as telephone communication, and also acquires information by cellular communication used in the positioning server 10 for positioning for its own terminal 20. The information which is acquired will be specifically described later. The cellular communication component 21 accumulates the acquired information in the data accumulation component 24.

Also, the cellular communication component 21 transmits and receives information to and from the positioning server 10 via the cellular base stations 30 (cellular communication network). The cellular communication component 21 provides the positioning server 10 with information, which is accumulated in the data accumulation component 24 and is used by the positioning server 10 for positioning, as measurement report information (Measurement Report) to be described in more detail later. Information transmitted from the cellular communication component 21 to the positioning server 10 includes information indicating the GPS positioning result to be described later. Also, the cellular communication component 21 includes reception GPS information indicating a GPS satellite from which a signal has been received by the cellular terminal 20 (its own terminal 20) as GPS measurement report information (Measurement Report) in the information transmitted from the cellular communication component 21 to the positioning server 10. The reception GPS information may include time information indicating a time when signals have been received and information indicating the quality of reception for each GPS satellite. Here, for example, a reception strength or pseudo-distance RMS error is used as the quality of reception. The transmission thereof is triggered by a user's operation on the terminal 20 or by a request from the positioning server 10, for example, when positioning for the cellular terminal 20 is performed.

The GPS reception component 22 is a unit for receiving signals, which are transmitted from GPS satellites 40 and used for positioning. The GPS reception component 22 is provided with an antenna for receiving signals from GPS satellites, and this antenna is used to perform reception. The GPS reception component 22 accumulates information, which is used for a GPS positioning calculation and is related to signals received from GPS satellites 40, as GPS measurement report information in the data accumulation component 24.

The above-described GPS satellites 40 are located at given locations depending on the time of day, and transmit positioning signals for use in positioning from the locations. More specifically, four or five GPS satellites 40 are disposed in each of six orbits at an altitude of about 20,000 km, and move along the orbit as time passes. The positioning signals transmitted by the GPS satellites 40 include identification information for identifying and specifying a GPS satellite 40, information indicating the orbit of the GPS satellites 40, and information indicating when a signal has been transmitted.

The GPS positioning calculation component 23 is one of position estimation unit for calculating the position of the terminal 20 by GPS positioning on the basis of the reception state of a signal from a GPS satellite 40 received by the GPS reception component 22. More specifically, the GPS positioning calculation component 23 acquires information about a signal received by the terminal 20 from a GPS satellite 40, which is received by the GPS reception component 22 and accumulated in the data accumulation component 24. Subsequently, from the above-described information, the GPS positioning calculation component 23 calculates the position of the GPS satellite 40, the distance from the cellular terminal 20 to the GPS satellite 40, and the like, and calculates the position of its own terminal 20. For this calculation, assist data acquired from the cellular communication system and indicating the position of the GPS satellite 40 or the like may be used (in which case the positioning will be AGPS (Assisted GPS) positioning). The start and end of signal reception by the GPS reception component 22 from the GPS satellite 40 and the GPS positioning calculation by the GPS positioning calculation component 23 are triggered, for example, by the receipt of an instruction from the positioning server 10 by the cellular terminal 20, as described later.

The GPS positioning calculation component 23 transmits information indicating a calculated position of the terminal 20 to the positioning server 10 as information about the positioning result of GPS positioning. When a calculation of the position of the terminal 20 by GPS positioning has failed, the GPS positioning calculation component 23 reports the failure to the positioning server 10. This information is included and transmitted in the measurement report information.

The data accumulation component 24 stores information for use in positioning acquired by each of the cellular communication component 21 and the GPS reception component 22. The above is the functional configuration of the cellular terminal 20.

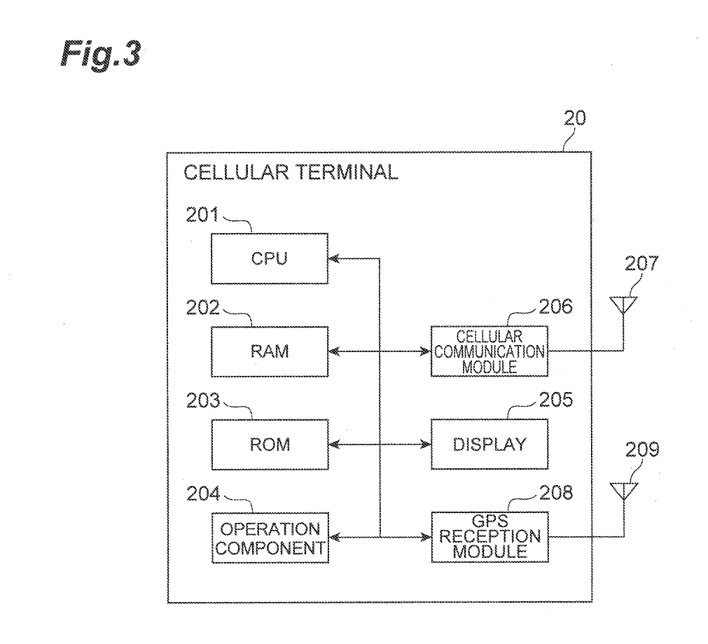

Subsequently, FIG. 3 shows the hardware configuration of the cellular terminal 20 according to this embodiment. As shown in FIG. 3, the cellular terminal 20 is constituted by hardware such as a CPU (central processing unit) 201, a RAM (random access memory) 202, a ROM (read only memory) 203, an operation component 204, a display 205, a cellular communication module 206, a cellular communication antenna 207, a GPS reception module 208, and a GPS reception antenna 209. The functions mentioned above are exhibited when these constituent elements operate. The above is the configuration of the cellular terminal 20.

Subsequently, the positioning server 10 will now be described. As shown in FIG. 1, the positioning server 10 includes a transmission/reception component 11, a GVM database 12, a GPS information acquisition component 13, a candidate estimation component 14, a reception state information acquisition component 15, an indoor/outdoor determination component 16, and a base station positioning calculation component 17.

The transmission/reception component 11 is a unit for transmitting and receiving information to and from the cellular terminal 20 via a cellular base station 30. The transmission/reception component 11 outputs information received from the cellular terminal 20 to the GPS information acquisition component 13 and the reception state information acquisition component 15 depending on the information.

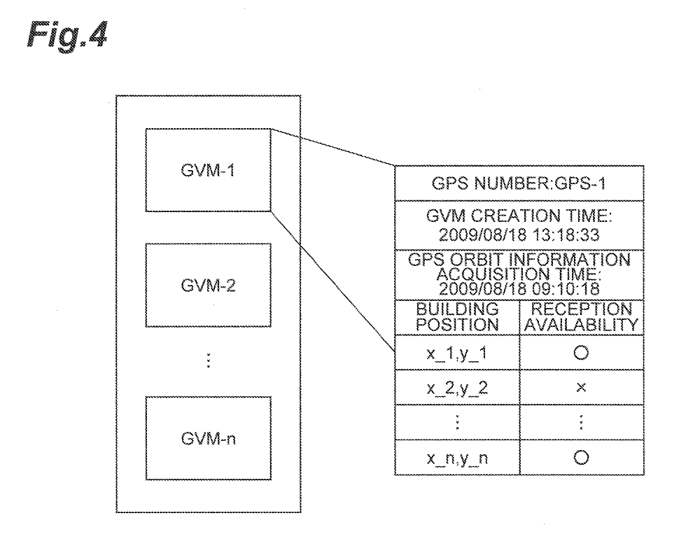

The GVM database 12 is a database storing the above-described GVM for each GPS satellite 40. As shown in FIG. 4, a GVM related to one GPS satellite 40 includes information of each of a “GPS number,” a “GVM creation time,” a “GPS orbit information acquisition time,” a “building position,” and “reception availability.” The “GPS number” is information for specifying the GPS satellite 40. The “GVM creation time” is the time when a GVM related to the GPS satellite 40 has been created. The “GPS orbit information acquisition time” is the time when GPS orbit information (specifically, almanac, ephemeris, and the like) indicating an orbit of the GPS satellite 40 has been acquired. On the basis of the GPS orbit information, a GPS position is calculated. The “building position” and the “reception availability” are associated and a plurality of items thereof is included in the GVM related to one GPS satellite 40. The “building position” is the center position of the above-described mesh in which a building is located, and is specifically information of the latitude and longitude. The “building position” may be information of a number or coordinates specifying the building. In this case, it is desirable to associate the latitude and longitude information to the number or coordinates (so that coordinate system conversion is possible).

The “reception availability” is information indicating whether or not signal reception from the GPS satellite 40 is possible in a position indicated by the “building position.” When the “reception availability” is marked by O, it indicates that the signal reception from the GPS satellite 40 is possible. When the “reception availability” is marked by X, it indicates that the signal reception from the GPS satellite 40 is not possible. The “reception availability” is not provided as information for each time (time band) in the example of FIG. 4, but it is desirable to provide the “reception availability” as information for each time (time band). However, when positioning is performed only at a specific time, information for each time (time band) may not be necessary. Also, it is not necessary to store GVMs of all GPS satellites 40. Even in this case, it is desirable to store a GVM for a GPS satellite 40 having a low elevation angle from which a radio wave can be received even though the cellular terminal 20 is located indoors. The created GVM may be classified by the GPS satellite 40. For example, the classification is performed on the basis of directions (for example, east, west, south, and north) or elevation angles (for example, 20 degrees or more, 10 to 20 degrees, . . . ), satellite numbers, and the like.

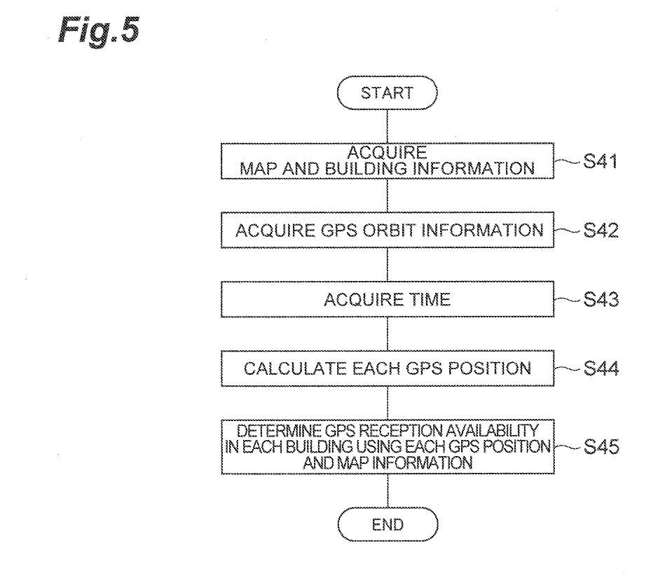

The GVMs stored in the GVM database 12 are created in advance. Here, a GVM creation method will be described. For example, the GVMs are created according to the flowchart of FIG. 5. A GVM creation process may be executed by the positioning server 10, and may be executed by a separate device (in this case, the created GVMs are input from the device to the positioning server 10).

As shown in FIG. 5, building information and map information are acquired (S41). The building information includes information of a position, height, and direction of a building, and a position, direction, and size of a window installed in a building. The map information includes information of topographies and surrounding obstacles (a mountain, a tree, and the like). The map information may not be necessary. Subsequently, GPS orbit information is acquired for each GPS satellite 40 (S42). Subsequently, time information related to the GVMs is acquired (S43). Subsequently, a position (an azimuth angle and an elevation angle) of the GPS satellite 40 is calculated for each GPS satellite 40 on the basis of the acquired time information and GPS orbit information (S44).

Subsequently, it is determined whether or not a signal from a GPS satellite 40 can be received for each GPS satellite 40 in each building position on the basis of the position of the GPS satellite 40, the building information, and the map information (S45). Specifically, for example, the determination is made by calculating and determining whether or not the GPS satellite 40 is directly viewed from a window. Also, after the strength of a signal received from the GPS satellite 40 is estimated, the determination is made on the basis of the received signal strength. This determination may be made using the related art. The determination result is stored in the GVM database 12 as the information of “reception availability.”

The GVM may be updated at the following timings. For example, the GVM may be updated in the case where the time elapsed from when a previous GVM has been created is equal to or greater than T₁, in the case where the time elapsed from when previous GPS start information has been acquired is equal to or greater than T₂, and in the case where the building information and the map information have been changed. T₁ and T₂ are preset system parameters, and for example, are 1 hour, 5 hours, and the like.

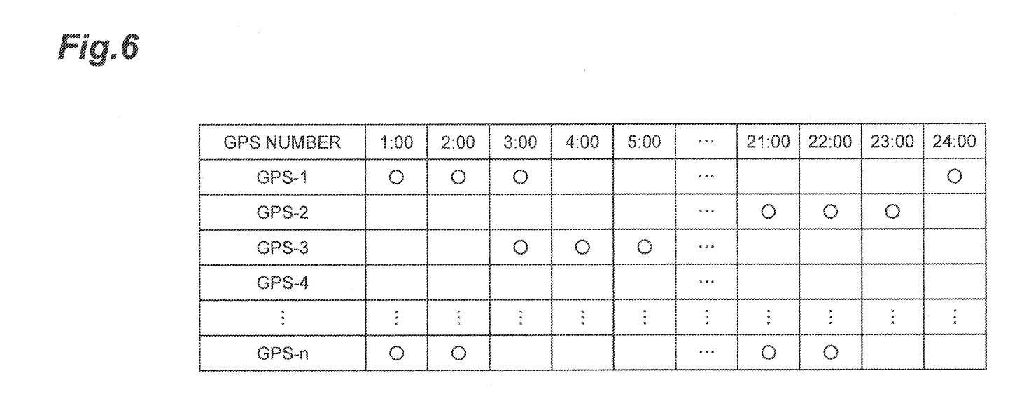

An example of determining whether or not a signal from a GPS satellite 40 can be received for each GPS satellite 40 in each building position in S45 has been described. Alternatively, it is possible to estimate a time band in which a signal from a GPS satellite 40 can be received in a positioning target area (for example, Japan) from GPS orbit information of each GPS satellite 40, and create a GVM by making the above-described determination in the above-described time band. Specifically, for example, a GPS position is calculated from the GPS orbit information every 1 hour, and a range in which a signal from a GPS satellite 40 can be received is calculated. When the positioning target area (for example, Japan) is included in the range, it is determined that a signal from the GPS satellite 40 can be received. FIG. 6 shows a table indicating a time band in which a signal can be received from each GPS satellite 40. When a GPS satellite 40 and a time band are marked by O, it indicates that a signal from the GPS satellite 40 can be received in the positioning target area. It is desirable that a GVM should be created for a GPS satellite 40 and a time band marked by O. Thereby, it is possible to reduce a calculation operation based on the building information and the map information.

The GPS information acquisition component 13 is a reception GPS information acquisition unit for acquiring reception GPS information indicating GPS satellites 40 from which signals for the cellular terminal 20 have been received. The reception GPS information is information for estimating candidates for the position of the cellular terminal 20 on the basis of GVMs. Specifically, the GPS information acquisition component 13 acquires the reception GPS information by receiving GPS measurement report information transmitted as the reception GPS information from the cellular terminal 20. The GPS information acquisition component 13 outputs the acquired reception GPS information to the candidate estimation component 14.

The GPS information acquisition component 13 receives information indicating the GPS positioning result from the cellular terminal 20. The GPS information acquisition component 13 controls the positioning process to be ended at the time of determining that the received GPS positioning result indicates successful positioning. Specifically, the GPS information acquisition component 13 transmits a signal to stop the positioning process to the cellular terminal 20 via the transmission/reception component 11. For example, a signal is transmitted to stop measurement for an MR. In the positioning server 10, the GPS information acquisition component 13 causes the base station positioning calculation component 17 to stop a process related to estimation of the position of the cellular terminal 20.

In contrast, when the GPS information acquisition component 13 determines that the received GPS positioning result indicates a positioning failure (that the position of the cellular terminal 20 is incapable of being estimated), candidates for the position of the cellular terminal 20 based on GVMs may be estimated and the position of the cellular terminal 20 may be estimated by the base station positioning calculation component 17 using the candidates.

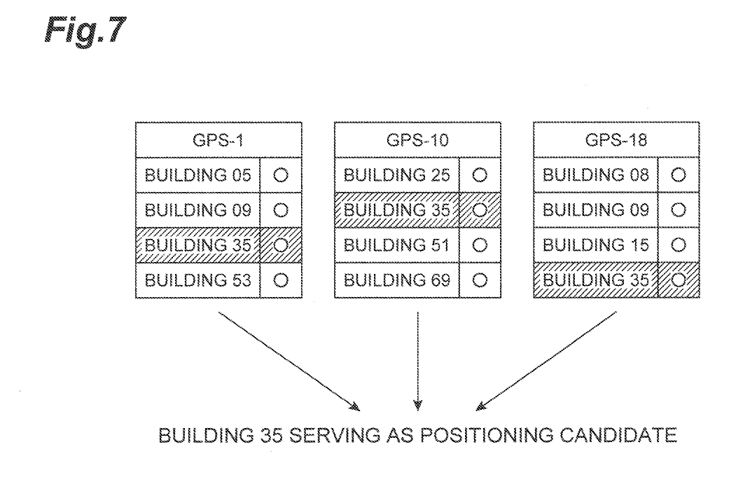

The candidate estimation component 14 is a candidate estimation unit for estimating candidates for the position of the cellular terminal 20 from the reception GPS information acquired by the GPS information acquisition component 13 on the basis of information stored in the GVM database 12. Specifically, the candidate estimation component 14 acquires GVMs related to GPS numbers included in the reception GPS information from the GVM database 12. For example, when there are 3 GPS numbers included in the reception GPS information such as “GPS-1,” “GPS-10,” and “GPS-18,” GVMs shown in FIG. 7 are acquired. The candidate estimation component 14 extracts building positions where a signal from a GPS satellite 40 can be received for each of all the acquired GVMs. The candidate estimation component 14 sets a common building position in all the acquired GVMs as the candidate for the position of the cellular terminal 20 among the extracted building positions. In the example of FIG. 7, a building position of “Building 35” becomes the candidate for the position of the cellular terminal 20. In the example of FIG. 7, the candidate for the position of the cellular terminal 20 becomes one building position (mesh), but the number of candidates may not be necessarily one. The candidate estimation component 14 outputs information indicating the estimated candidate for the position of the cellular terminal 20 (for example, information indicating the mesh) to the base station positioning calculation component 17.

When time information indicating the time when signals have been received is included in the reception GPS information, the candidate estimation component 14 acquires a GVM related to the time indicated by the time information.

The candidate estimation component 14 may decide GVMs to be used for estimating the candidates for the position of the cellular terminal 20 on the basis of information indicating the quality of reception of signals from GPS satellites included in the reception GPS information. For example, only GVMs of the top n GPS satellites 40 of the quality of reception may be used among all GPS satellites 40 from which signals have been received by the cellular terminal 20. Here, n is a parameter which is preset. Among all the GPS satellites 40 from which signals have been received by the cellular terminal 20, only GVMs of GPS satellites 40 of which the quality of reception has exceeded a preset threshold value may be used.

Not only a common building position of all the acquired GVMs may be set as the candidate for the position of the cellular terminal 20 as described above, but also m or more common building positions among all the acquired GVMs may be set as the candidate for the position of the cellular terminal 20. Here, m is a parameter which is preset. For example, when the total number of acquired GVMs is M, m=M/2 or m=M−1.

The reception state information acquisition component 15 is a reception state information acquisition unit for acquiring reception state information transmitted from the cellular terminal 20 via the transmission/reception component 11, wherein the reception state information indicates a state of radio wave reception by the cellular communication component 21 of the cellular terminal 20. As the reception state information, strength information indicating reception strength corresponding to the cellular base station 30 which is a transmission source of a radio wave is used. More specifically, measurement report information (Measurement Report (hereinafter, referred to as MR)) including identification information of the cellular base station 30 (a cell ID, a base station ID, and the like), which is information measured in the cellular terminal 20, is used. In addition to the identification information of the cellular base station 30, the MR includes information indicating a signal transmission delay (such as the RTT (round trip time)) and the reception strength (reception level) of a received signal associated with the identification information, information indicating the amount of attenuation or the amount of interference, information indicating whether or not GPS positioning is possible, and the like. When the MR is acquired, the reception state information acquisition component 15 outputs the MR to the indoor/outdoor determination component 16 and the base station positioning calculation component 17. The MR is acquired continuously at regular time intervals or the like.

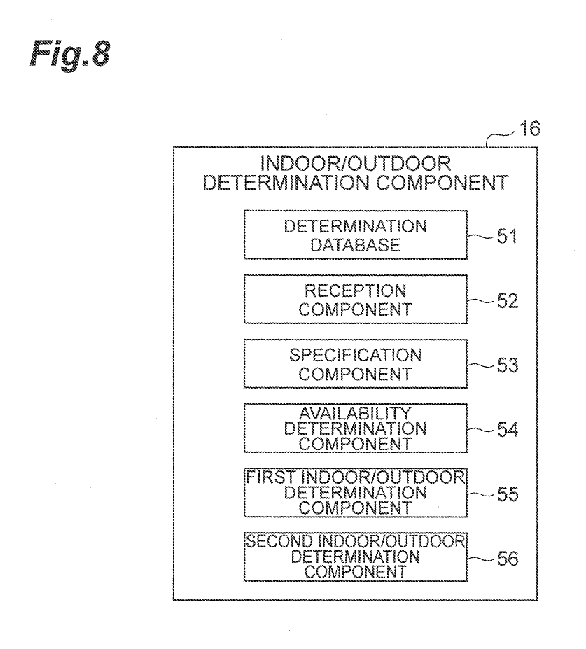

The indoor/outdoor determination component 16 is an indoor/outdoor determination unit for determining whether the cellular terminal 20 is located indoors or outdoors on the basis of the MR inputted from the reception state information acquisition component 15. More specifically, as shown in FIG. 8, the indoor/outdoor determination component 16 includes a determination database 51, a reception component 52, a specification component 53, an availability determination component 54, a first indoor/outdoor determination component 55, and a second indoor/outdoor determination component 56.

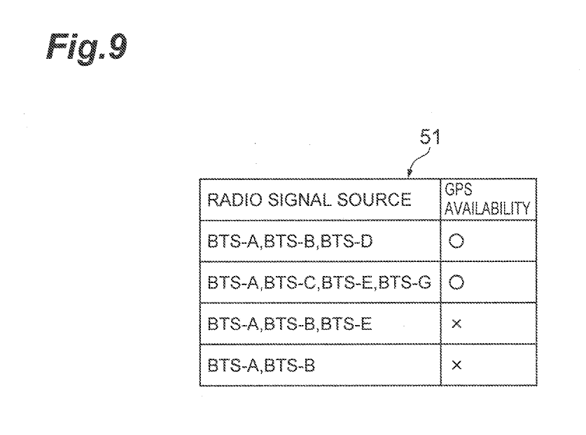

As shown in FIG. 9, the determination database 51 stores information by associating combination information of identification information about outdoor transmission sources assumed to be transmission sources (cellular base stations 30) of signals simultaneously received by the cellular terminal 20 with indoor/outdoor characteristic information expressing the indoor or outdoor characteristics of the cellular terminal 20 at the time of signal receipt (as an example here, information indicating whether or not GPS positioning is possible (hereinafter referred to as GPS availability information)). For example, FIG. 9 shows the actual result in which signals have been received simultaneously from transmission sources BTS-A, BTS-B, and BTS-D and GPS positioning has been possible at the time, and shows the actual result in which signals have been received simultaneously from transmission sources BTS-A, BTS-B, and BTS-E and GPS positioning has not been possible at the time. The configuration of the determination database 51 will be described later.

The reception component 52 receives an MR including identification information of transmission sources of received signals from the cellular terminal 20. The specification component 53 specifies the number of transmission sources, N, of received signals from the received MR. The availability determination component 54 determines whether or not the number of transmission sources, N, is equal to or greater than the minimum number of transmission sources, M, for which an indoor/outdoor determination based on a first indoor/outdoor determination method to be described later is possible. The minimum number of transmission sources, M, is a preset value.

When the number of transmission sources, N, is equal to or greater than the minimum number of transmission sources, M, (that is, when the indoor/outdoor determination based on the first indoor/outdoor determination method is possible), the first indoor/outdoor determination component 55 makes the indoor/outdoor determination on the basis of the first indoor/outdoor determination method. Here, for example, in the indoor/outdoor determination based on the first indoor/outdoor determination method, an approximate position of the cellular terminal 20 is calculated by matching the MR from the cellular terminal 20 with a pre-stored positioning database in an environment where pattern matching positioning is performed, and the indoor/outdoor determination is made on the basis of the presence/absence of a contradiction between measured data of the MR and predicted data in the approximate position.

When the number of transmission sources, N, is less than the minimum number of transmission sources, M (that is, when the indoor/outdoor determination based on the first indoor/outdoor determination method is impossible), the second indoor/outdoor determination component 56 makes an indoor/outdoor determination based on a second indoor/outdoor determination method described in detail later.

On the basis of the indoor/outdoor determination result for the cellular terminal 20, the indoor/outdoor determination component 16 controls a positioning process in the positioning server 10. Specifically, at the time of determining that the cellular terminal 20 is located indoors, the indoor/outdoor determination component 16 causes the estimation of candidates for the position of the cellular terminal 20 to be performed by GVMs and causes the estimation of the position of the cellular terminal 20 to be performed using the candidates. At the time of determining that the cellular terminal 20 is located outdoors, the indoor/outdoor determination component 16 causes GPS positioning to be performed or causes the positioning server 10 to have a state of the GPS positioning result.

The base station positioning calculation component 17 is a position estimation unit for estimating the position of the cellular terminal 20 from the candidates for the position of the cellular terminal 20 estimated by the candidate estimation component 14 and the MR acquired by the reception state information acquisition component 15. For example, the position of the cellular terminal 20 is estimated on the basis of the MR by a method of performing a positioning calculation by pattern matching illustrated in Patent Document 1. That is, the base station positioning calculation component 17 keeps information in memory by storing the information indicating the relationship between the reception strength of a radio wave received from a given cellular base station 30 and the position where the radio wave is received in a database. The base station positioning calculation component 17 performs a matching process for the information stored in the database and the reception strength corresponding to the cellular base station 30 indicated by the MR, and sets a position associated with the reception strength of a pattern similar to the reception strength indicated by the MR as a candidate for the position of the cellular terminal 20.

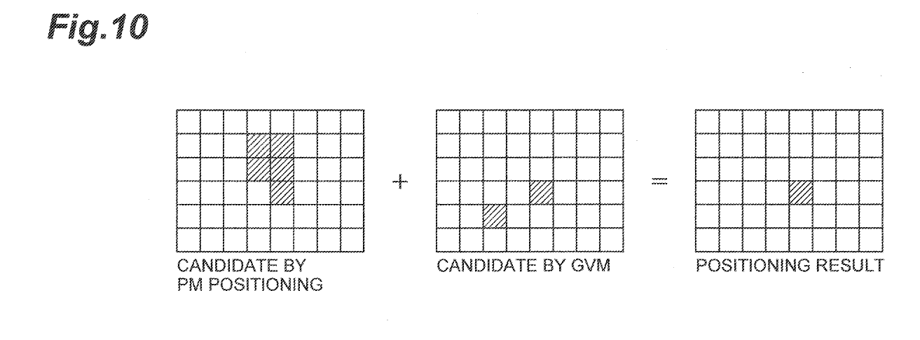

The base station positioning calculation component 17 estimates the position of the cellular terminal 20 from the candidate for the position of the cellular terminal 20 estimated by the positioning calculation by the pattern matching and the candidate for the position of the cellular terminal 20 estimated by the candidate estimation component 14. For example, as shown in FIG. 10, the base station positioning calculation component 17 sets (a candidate for) a common position of candidates for the position of the cellular terminal 20 estimated by a positioning calculation by pattern matching and candidates (candidates by the GVM) for the position of the cellular terminal 20 estimated by the candidate estimation component 14 as the position of the cellular terminal 20. In the positioning calculation by pattern matching, a positioning error may be estimated to determine the end of positioning as in a method of the related art, and MRs measured at a plurality of timings may be used.

In addition to the above, for example, the position of the cellular terminal 20 may be estimated by producing a distance between the cellular terminal 20 and each cellular base station 30 on the basis of an RTT and estimating a candidate for the position of the cellular terminal 20 on the basis of the produced distance. In this case, the base station positioning calculation component 17 stores in advance information indicating the position of the cellular base station 30.

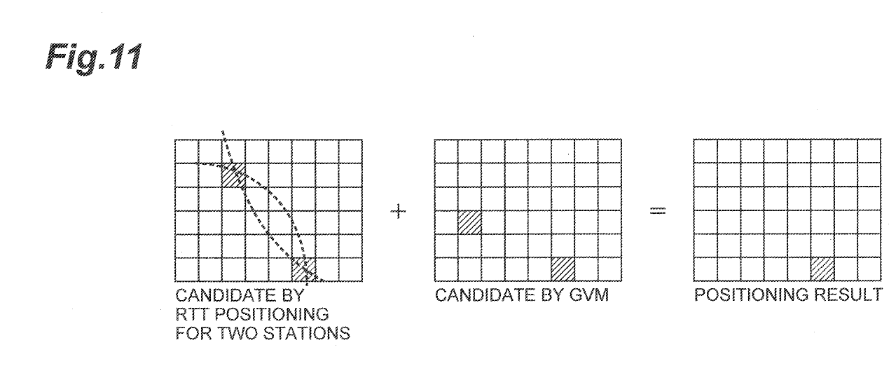

The base station positioning calculation component 17 estimates the position of the cellular terminal 20 from the candidate for the position of the cellular terminal 20 estimated by the positioning calculation by the RTT and the candidate for the position of the cellular terminal 20 estimated by the candidate estimation component 14. For example, as shown in FIG. 11, the base station positioning calculation component 17 sets (a candidate for) a common position of candidates for the position of the cellular terminal 20 estimated by distances among two cellular base stations 30 and the cellular terminal 20 (intersection points between the above-described distances from the two cellular base stations 30) and candidates (candidates by the GVM) for the position of the cellular terminal 20 estimated by the candidate estimation component 14 as the position of the cellular terminal 20.

When one of the two methods of estimating the position of the cellular terminal 20 by the base station positioning calculation component 17 is used, it is possible to reliably obtain the highly accurate positioning result based on a reception state. However, any method may be used as long as an estimation method is based on the reception state of a radio wave from the cellular base station 30 without having to use one of the two methods.

The base station positioning calculation component 17 transmits information indicating the position of the cellular terminal 20 estimated as described above to the cellular terminal 20, or outputs the information depending on use content. It is desirable for the base station positioning calculation component 17 to estimate the position of the cellular terminal 20 when the indoor/outdoor determination component 16 determines that the cellular terminal 20 is located indoors (when the determination information thereof is input from the indoor/outdoor determination component 16). Also, it is desirable for the base station positioning calculation component 17 to estimate the position of the cellular terminal 20 when GPS positioning has failed (when the GPS information acquisition component 13 has acquired the failure information from the cellular terminal 20 or has not acquired successful GPS positioning information for a fixed time). According to this configuration, the position of the cellular terminal 20 is estimated as described above only when necessary. The above is the functional configuration of the positioning server 10.

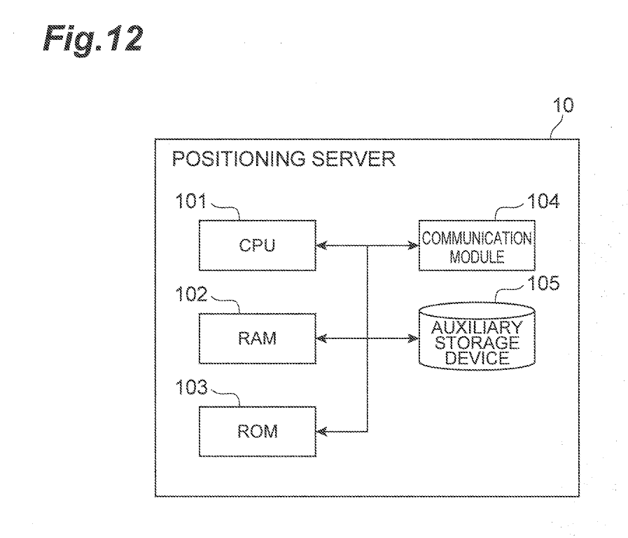

FIG. 12 illustrates the hardware configuration of the positioning server 10. As shown in FIG. 12, the positioning server 10 is constituted by including a computer having hardware such as a CPU 101, a RAM 102 and a ROM 103 as main storage devices, a communication module 104 for performing communication, and an auxiliary storage device 105 such as a hard disk. These constituent elements operate under programs or the like, thereby exhibiting the functions of the positioning server 10 described above.

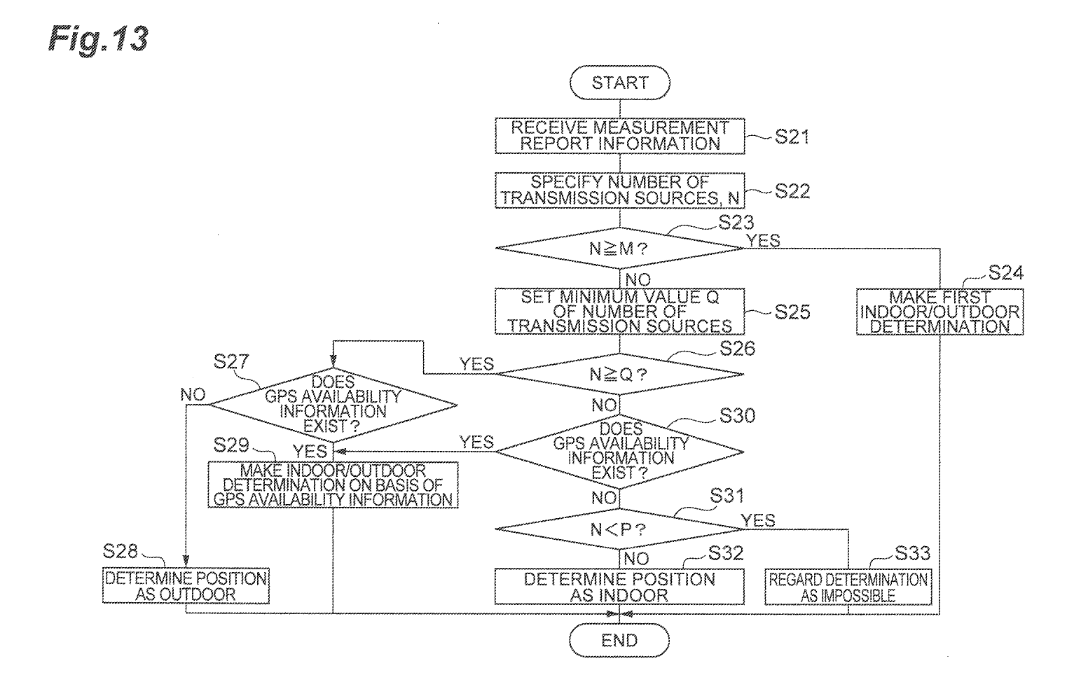

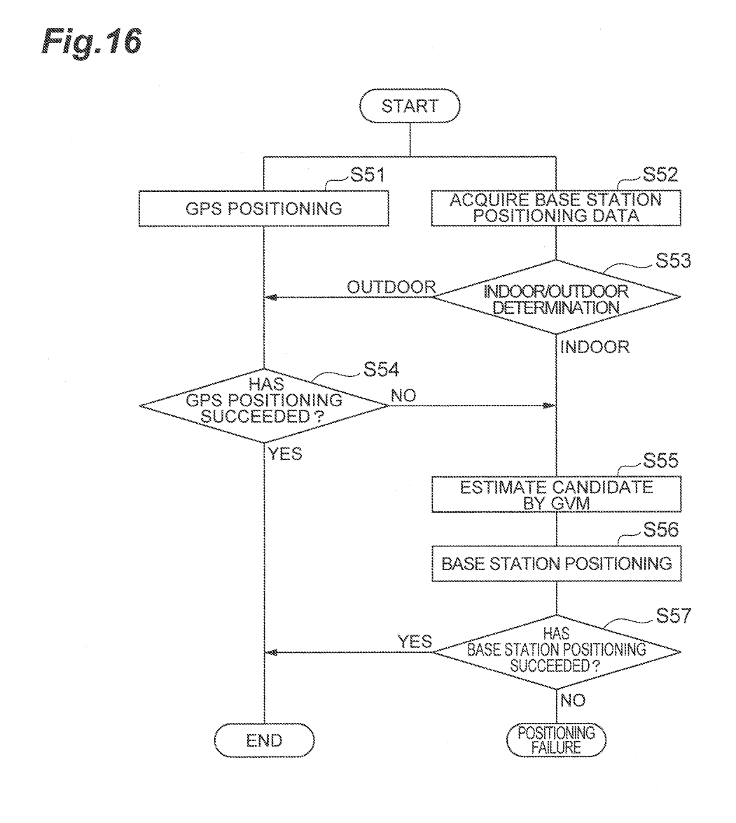

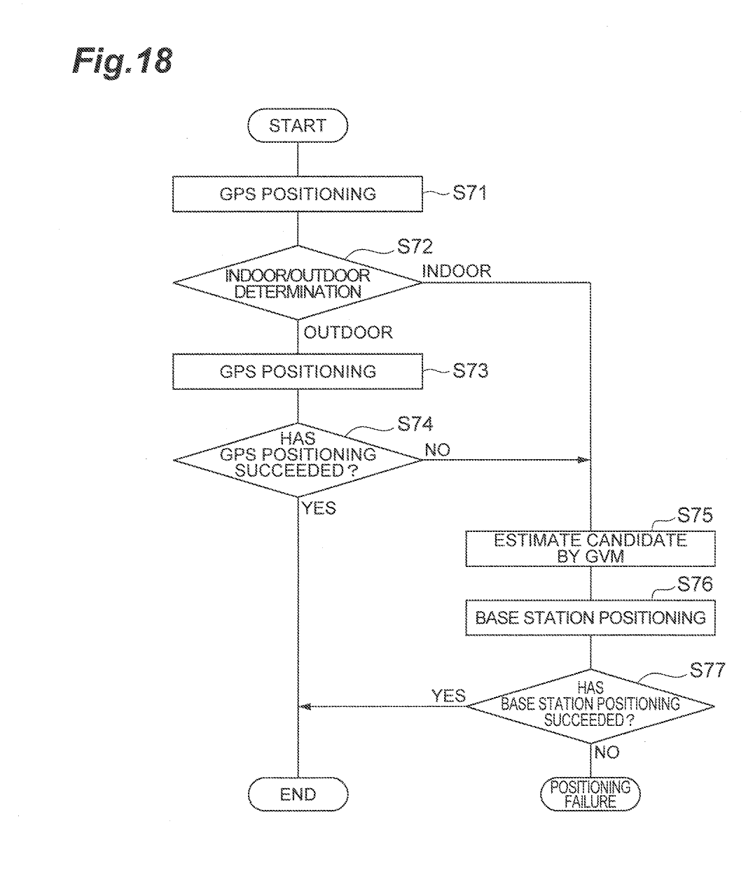

Subsequently, the indoor/outdoor determination process (indoor/outdoor determination method) to be executed by the indoor/outdoor determination component 16 in this embodiment will be described using the flowchart of FIG. 13. This process is executed, for example, in indoor/outdoor determination steps (S53 of FIGS. 16 and S72 of FIG. 18) by the indoor/outdoor determination component 16 in a positioning process (FIGS. 16 and 18) to be described later.

First, in the indoor/outdoor determination component 16, the reception component 52 receives an MR including information for identifying transmission sources of received signals from the cellular terminal 20 (S21 in FIG. 13), and the specification component 53 specifies the number of transmission sources, N, of received signals by counting the number of pieces of the identification information of the transmission sources of received signals included in the received MR (S22). For example, when the identification information of transmission sources included in the MR is two of “BTS-A” and “BTS-B,” the number of transmission sources, N, is specified as “2.” In terms of the transmission sources, received signals belonging to the same cell may be treated as those from the same transmission source, and received signals from different sectors belonging to the same cell may be treated as those from different transmission sources.

The availability determination component 54 determines whether or not the number of transmission sources, N, is equal to or greater than the minimum number of transmission sources, M, for which the indoor/outdoor determination is possible on the basis of the first indoor/outdoor determination method (S23).

When the number of transmission sources, N, is equal to or greater than the minimum number of transmission sources, M, in S23, it can be determined that the indoor/outdoor determination is possible on the basis of the first indoor/outdoor determination method, so the first indoor/outdoor determination component 55 makes the indoor/outdoor determination on the basis of the first indoor/outdoor determination method (S24). Here, for example, the approximate position of the cellular terminal 20 is calculated by matching the MR from the cellular terminal 20 with a pre-provided positioning database (not shown), and the indoor or outdoor determination is made on the basis of the presence/absence of a contradiction between the measured data in the MR and the predicted data in the approximate position. An extent P of being indoors is calculated by the magnitude of the contradiction between measurement data M and predicted data D in the approximate position. For instance, P=(D−M)/M, where a value less than 0 is set as 0, and a value equal to or greater than 1 is set as 1.

On the other hand, when the number of transmission sources, N, is less than the minimum number of transmission sources, M, in S23, it can be determined that the indoor/outdoor determination is impossible on the basis of the first indoor/outdoor determination method, so that the second indoor/outdoor determination component 56 makes the indoor/outdoor determination on the basis of the following second indoor/outdoor determination method.

The second indoor/outdoor determination component 56 extracts combination information including all identification information of transmission sources included in the MR and GPS availability information corresponding to the combination information from the determination database 51, and sets a minimum value of the number of transmission sources included in the extracted combination information as the minimum value Q of the number of transmission sources (S25).

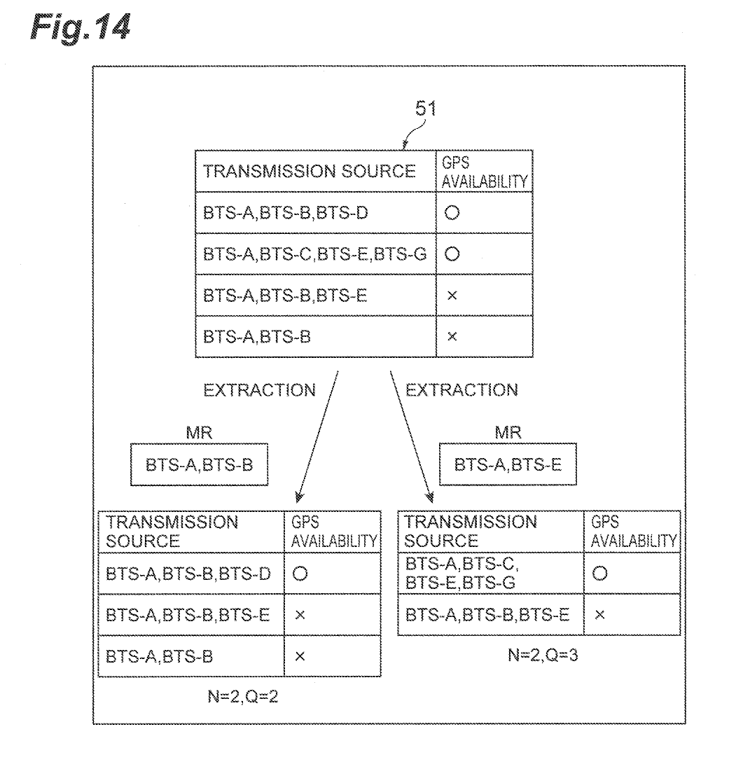

As a specific example, when the transmission source identification information (BTS-A, BTS-B) is included in the MR as shown in FIG. 14, combination information of three combinations of (BTS-A, BTS-B, BTS-D), (BTS-A, BTS-B, BTS-E), and (BTS-A, BTS-B) as combination information including all the transmission source identification information (BTS-A, BTS-B), and GPS availability information corresponding thereto are extracted from the determination database 51. The lowest value “2” of values (“3,” “3,” and “2” here) of the number of transmission sources included in the above-mentioned combination information of the three combinations is set as the minimum value Q of the number of transmission sources.

As another example, when the transmission source identification information (BTS-A, BTS-E) is included in the MR, combination information of two combinations (BTS-A, BTS-C, BTS-E, BTS-G) and (BTS-A, BTS-B, BTS-E) as the combination information including all the transmission source identification information (BTS-A and BTS-E), and GPS availability information corresponding thereto are extracted from the determination database 51. The lowest value “3” of values (“4” and “3” here) of the numbers of transmission sources included in the above-mentioned combination information of the two combinations is set as the minimum value Q of the number of transmission sources.

Next, the second indoor/outdoor determination component 56 determines whether or not the number of transmission sources, N, is equal to or greater than the minimum value Q of the number of transmission sources (S26). When the number of transmission sources, N, is equal to or greater than the minimum value Q of the number of transmission sources in S26, it can be determined that the cellular terminal 20 receives signals from transmission sources whose number is equal to or greater than the minimum number of transmission sources, Q, so that the cellular terminal 20 is considered to be located outdoors. It is checked whether or not there is GPS availability information corresponding to the same combination information as the combination of transmission source identification information included in the MR (S27). When the GPS availability information exists, the indoor/outdoor determination is made on the basis of the GPS availability information (S29). When there is no GPS availability information, it is determined that the cellular terminal 20 is located outdoors (S28). When the GPS availability information exists and the indoor/outdoor determination is made on the basis of the GPS availability information, an extent of matching with the GPS availability information is set as an extent to which the cellular terminal 20 is located indoors. When there is no GPS availability information, the extent P to which the cellular terminal 20 is located outdoors is calculated from a difference between N and Q. For example, P=A(Q−N)/N, where P equal to or greater than 1 is set as 1 and P less than 0 is set as 0. A is a coefficient which is a system parameter.

On the other hand, when the number of transmission sources, N, is less than the minimum number of transmission sources, M, in S26, it is checked whether or not there is GPS availability information corresponding to the same combination information as the combination of transmission source identification information included in the MR (S30). When the GPS availability information exists, the indoor/outdoor determination is made on the basis of the GPS availability information (S29). When there is no GPS availability information, it is determined whether or not the number of transmission sources, N, is less than the minimum number of transmission sources, P, for which the indoor/outdoor determination is possible on the basis of the second indoor/outdoor determination method (S31). When the number of transmission sources, N, is less than the minimum number of transmission sources, P, it is determined that the indoor/outdoor determination is impossible on the basis of the second indoor/outdoor determination method (S33). On the other hand, when the number of transmission sources, N, is equal to or greater than the minimum number of transmission sources, P, in S31, it is determined that the indoor/outdoor determination is possible on the basis of the second indoor/outdoor determination method, but it is determined that the cellular terminal 20 is located indoors since it may be determined that the cellular terminal 20 does not receive signals from transmission sources whose number is equal to or greater than the minimum number of transmission sources, M, and the reception state is inferior (S32).

The indoor/outdoor determination process of FIG. 13 as described above is able to quickly obtain the determination result as to whether the cellular terminal 20 is located indoors or outdoors or whether the determination is impossible.

As described above, the positioning server 10 according to this embodiment controls the execution of the indoor/outdoor determination based on the first indoor/outdoor determination method on the basis of the result of comparing the number of transmission sources, N, to the minimum number of transmission sources, M, and is able to quickly make the changeover to the execution of the indoor/outdoor determination based on the second indoor/outdoor determination method when the execution of the indoor/outdoor determination based on the first indoor/outdoor determination method is impossible. Also, when there is GPS availability information in the indoor/outdoor determination based on the second indoor/outdoor determination method, the indoor/outdoor determination may be properly made on the basis of the GPS availability information. When there is no GPS availability information, the indoor/outdoor determination may be properly made on the basis of the number of transmission sources, N, the minimum value Q of the number of transmission sources, and the minimum number of transmission sources, P, for which the second indoor/outdoor determination method is possible.

For example, the determination database 51 may be configured as follows. First, the determination database 51 may be configured by extracting necessary information (identification information of a transmission source of a received signal or GPS availability information) from a positioning database (not shown) storing information included in the MR (such as identification information of a transmission source of a received signal, a received signal level, information indicating a signal transmission delay, information indicating an amount of attenuation, GPS availability information, and the like). The above-mentioned positioning database may also be utilized directly as a determination database.

Second, the determination database 51 may be configured using measurement information obtained in the course of configuring a positioning database and ordinary positioning. The second method may be divided into two types of a method using measured data and a method using predicted data.

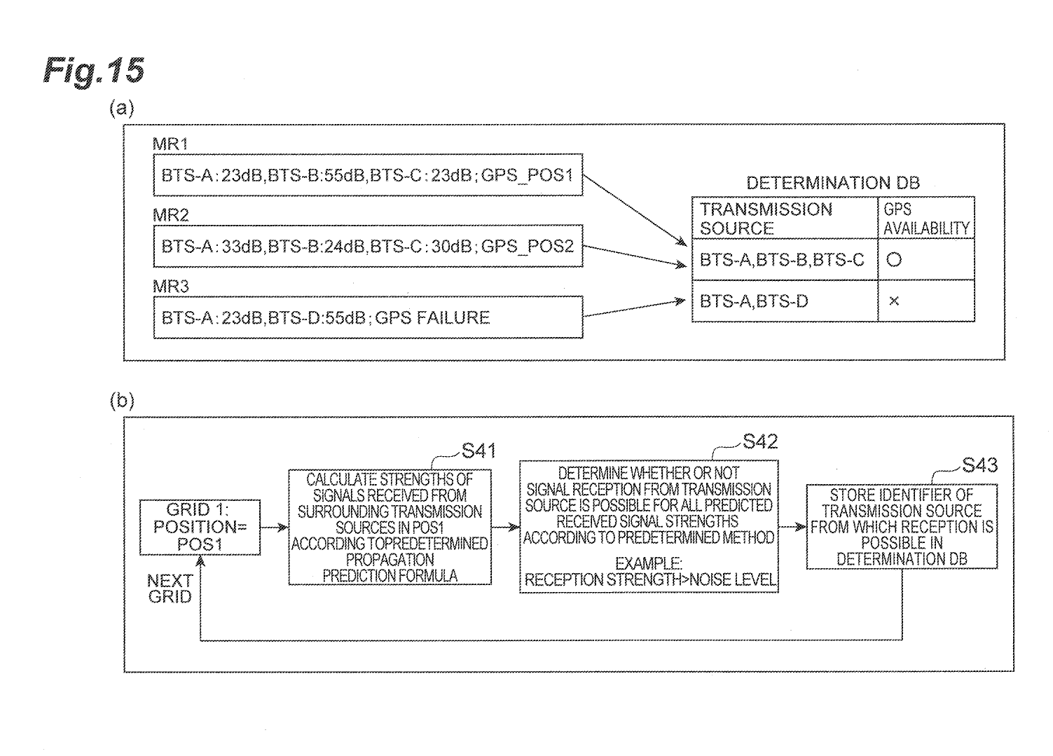

The method using measured data creates a database by associating transmission source identification information measured by the cellular terminal with GPS positioning availability. For example, as shown in (a) of FIG. 15, MR1, MR2, and MR3 including measurement data are received, a database is created by associating a combination of transmission source identification information from MR1 and MR2 (BTS-A, BTS-B, BTS-C) with information that GPS positioning is possible, and a database is created by associating a combination of transmission source identification information from MR3 (BTS-A, BTS-D) with information that GPS positioning is impossible, thereby configuring the determination database in (a) of FIG. 15.

On the other hand, the method using predicted data creates a database by assuming that all grids (individual locations into which a measured area is divided in a mesh pattern) are outdoors and creating predicted data from a propagation prediction formula considering topographies and surrounding obstacles in each grid. For example, as shown in (b) of FIG. 15, the strengths of signals received from all surrounding transmission sources are calculated in a certain grid (position: POS1) according to a predetermined propagation prediction formula (S41). It is determined whether the signal reception from a transmission source is possible or impossible for all predicted received signal strengths according to a predetermined method (S42). For example, a predetermined noise level is used as a reference, it is determined that the signal reception from a transmission source is possible when the reception strength is higher than the noise level, and it is determined that the signal reception from a transmission source is impossible when the reception strength is equal to or less than the noise level. A combination of identifiers of transmission sources from which reception is determined to be possible is stored in the determination database (S43). Thereafter, the determination database is configured by performing steps S41 to S43 for each grid.

Subsequently, a positioning process (positioning method) to be executed by the positioning system 1 according to this embodiment will be described using the flowchart of FIG. 16. For example, this process is started by the positioning server 10 receiving a positioning request via a cellular communication network after a positioning request is transmitted to the positioning server 10 by the user performing an operation of starting the positioning process on the cellular terminal 20. Also, the positioning process may be started using something other than the above as a trigger.

First, the signal reception by the GPS reception component 22 from the GPS satellite 40 and the GPS positioning calculation by the GPS positioning calculation component 23 (which are GPS positioning) are started in the cellular terminal 20 (S51 as the position estimation step). On the other hand, the cellular communication component 21 of the cellular terminal 20 measures reception state information indicating a reception state of a radio wave and transmits the information as an MR to the positioning server 10. Subsequently, the positioning server 10 receives the MR by the reception state information acquisition component 15 via the transmission/reception component 11 (S52 as the reception state information acquisition step). The MR received by the reception state information acquisition component 15 is output to the indoor/outdoor determination component 16 and the base station positioning calculation component 17.

Subsequently, the indoor/outdoor determination component 16 determines whether the cellular terminal 20 is located indoors or outdoors on the basis of the MR input from the reception state information acquisition component 15 (S53 as the indoor/outdoor determination step).

At the time of determining that the cellular terminal 20 is located outdoors as the determination result of the indoor/outdoor determination component 16, the positioning server 10 waits for the result of GPS positioning started in S51. When the GPS positioning by the GPS reception component 22 and the GPS positioning calculation component 23 has failed or succeeded (that is, when the positioning result having a fixed accuracy has been obtained) in the cellular terminal 20, the cellular communication component 21 transmits information of the positioning result to the positioning server 10. In the cellular terminal 20, the cellular communication component 21 provides the positioning server 10 with GPS measurement report information obtained by the GPS reception component 22 as reception GPS information. The positioning server 10 receives positioning result information by GPS positioning and GPS measurement report information by the GPS information acquisition component 13 via the transmission/reception component 11. The GPS measurement report information is output from the GPS information acquisition component 13 to the candidate estimation component 14 (S54 as the reception GPS information acquisition step).

The positioning server 10 determines whether or not the positioning result information by the GPS positioning received by the GPS information acquisition component 13 is successful (that is, whether or not the GPS positioning is fixed) (S54). When it is determined that the positioning result information by the GPS positioning is successful, the positioning result by the GPS positioning is regarded as the final positioning result and the positioning process is ended.

At the time of determining that the cellular terminal 20 is located outdoors as the determination result of the indoor/outdoor determination component 16 in S53 and determining that the positioning result information by the GPS positioning by the GPS information acquisition component 13 is unsuccessful in S54, a candidate for the position of the cellular terminal 20 is estimated using GVMs (S55).

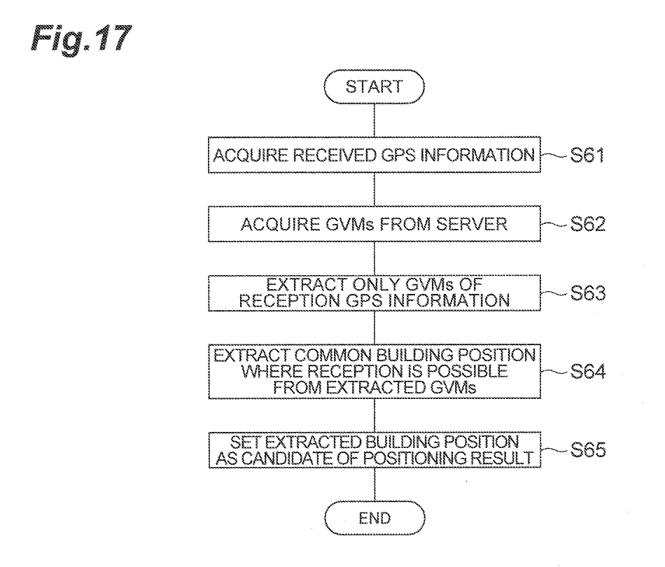

The estimation of candidates for the position of the cellular terminal 20 using GVMs will be described using the flowchart of FIG. 17. First, the positioning server 10 acquires reception GPS information by the GPS information acquisition component 13 (S61 as the reception GPS information acquisition step). Specifically, for example, the reception GPS information is acquired as follows. When this process is executed via S54, the reception GPS information has already been acquired by the GPS information acquisition component 13. When this process is executed without involving S54, a transmission request signal for the reception GPS information is transmitted from the GPS information acquisition component 13 to the cellular terminal 20. The cellular terminal 20 transmits GPS measurement report information measured and obtained by the GPS reception component 22 to the positioning server 10. The transmitted GPS measurement report information is received by the GPS information acquisition component 13 of the positioning server 10. The acquired reception GPS information is output from the GPS information acquisition component 13 to the candidate estimation component 14.

Subsequently, the candidate estimation component 14 acquires GVMs from the GVM database 12 (S62 as the candidate estimation step). Subsequently, the candidate estimation component 14 extracts only GVMs related to GPS numbers included in the reception GPS information from the GVMs (S63 as the candidate estimation step). When time information is included in the reception GPS information, only GVMs corresponding to the time information are extracted. Subsequently, the candidate estimation component 14 extracts building positions where signal reception from the GPS satellite 40 is possible for each of all the extracted GVMs (S64 as the candidate estimation step). Subsequently, the candidate estimation component 14 regards a common building position between all the acquired GVMs among the extracted building positions as a candidate for the position of the cellular terminal 20 (S65 as the candidate estimation step). Information indicating the estimated candidate for the position of the cellular terminal 20 is output from the candidate estimation component 14 to the base station positioning component 17.

Subsequently, returning to FIG. 16, the base station positioning component 17 estimates the position of the cellular terminal 20 from a candidate for the position of the cellular terminal 20 estimated by the candidate estimation component 14 and an MR acquired by the reception state information acquisition component 15 (base station positioning) (S56 as the position estimation step). When the base station positioning calculation component 17 has successfully estimated the position of the cellular terminal 20, the positioning result is regarded as the final positioning result and the positioning process is ended (S57). When both the estimation of the position of the cellular terminal 20 by the base station positioning calculation component 17 and the GPS positioning have succeeded, any positioning result may be regarded as the final positioning result. In general, it is desirable to use the positioning result of the GPS positioning since the GPS positioning has a high accuracy.

On the other hand, when the estimation of the position of the cellular terminal 20 by the base station positioning calculation component 17 has failed, the final positioning result is regarded as a positioning failure and the positioning process is ended (S57).

Information indicating the final positioning result obtained as described above (information indicating the estimated position of the cellular terminal 20 or information indicating the positioning failure) is transmitted to the cellular terminal 20 or is output depending on use content. The above is the positioning process (positioning method) executed by the positioning system 1 according to this embodiment.

Subsequently, another example of the positioning process (positioning method) to be executed by the positioning system 1 according to this embodiment will be described using the flowchart of FIG. 18. For example, this process is started by the positioning server 10 receiving a positioning request via a cellular communication network after a positioning request is transmitted to the positioning server 10 by the user performing an operation of starting the positioning process on the cellular terminal 20. Also, the positioning process may be started using something other than the above as a trigger.

First, the cellular communication component 21 of the cellular terminal 20 measures reception state information indicating a reception state of a radio wave and transmits the information as an MR to the positioning server 10. Subsequently, the positioning server 10 receives the MR by the reception state information acquisition component 15 via the transmission/reception component 11 (S71 as the reception state information acquisition step). The MR received by the reception state information acquisition component 15 is output to the indoor/outdoor determination component 16 and the base station positioning calculation component 17.

Subsequently, the indoor/outdoor determination component 16 determines whether the cellular terminal 20 is located indoors or outdoors on the basis of the MR input from the reception state information acquisition component 15 (S72 as the indoor/outdoor determination step).

At the time of determining that the cellular terminal 20 is located outdoors as the determination result of the indoor/outdoor determination component 16, a control signal by which GPS positioning is performed is transmitted from (the indoor/outdoor determination component 16 of) the positioning server 10 to the cellular terminal 20. When the control signal is received, the signal reception by the GPS reception component 22 from the GPS satellite 40 and the GPS positioning calculation by the GPS positioning calculation component 23 (which are GPS positioning) are started (S73 as the position estimation step) in the cellular terminal 20.

When the GPS positioning by the GPS reception component 22 and the GPS positioning calculation component 23 has failed or succeeded in the cellular terminal 20 (that is, when the positioning result having a fixed accuracy has been obtained), the cellular communication component 21 transmits positioning result information to the positioning server 10. In the cellular terminal 20, the cellular communication component 21 provides the positioning server 10 with GPS measurement report information obtained by the GPS reception component 22 as reception GPS information. The positioning server 10 receives positioning result information by GPS positioning and GPS measurement report information by the GPS information acquisition component 13 via the transmission/reception component 11. The GPS measurement report information is output from the GPS information acquisition component 13 to the candidate estimation component 14 (S74 as the reception GPS information acquisition step).

The positioning server 10 determines whether or not the positioning result information by the GPS positioning received by the GPS information acquisition component 13 is successful (that is, whether or not the GPS positioning is fixed) (S74). When it is determined that the positioning result information by the GPS positioning is successful, the positioning result by the GPS positioning is regarded as the final positioning result and the positioning process is ended.

At the time of determining that the cellular terminal 20 is located outdoors as the determination result of the indoor/outdoor determination component 16 in S72 and determining that the positioning result information by the GPS positioning by the GPS information acquisition component 13 is unsuccessful in S74, candidates for the position of the cellular terminal 20 are estimated using GVMs (S74). This process is executed by the candidate estimation component 14 as described above using FIG. 17 Information indicating the estimated candidate for the position of the cellular terminal 20 is output from the candidate estimation component 14 to the base station positioning calculation component 17.

Subsequently, the base station positioning component 17 estimates the position of the cellular terminal 20 from the candidates for the position of the cellular terminal 20 estimated by the candidate estimation component 14 and an MR acquired by the reception state information acquisition component 15 (base station positioning) (S76 as the position estimation step). When the base station positioning calculation component 17 has successfully estimated the position of the cellular terminal 20, the positioning result is regarded as the final positioning result and the positioning process is ended (S77). When both the estimation of the position of the cellular terminal 20 by the base station positioning calculation component 17 and the GPS positioning have succeeded, any positioning result may be regarded as the final positioning result. In general, it is desirable to use the positioning result of the GPS positioning since the GPS positioning has a high accuracy.

On the other hand, when the estimation of the position of the cellular terminal 20 by the base station positioning calculation component 17 has failed, the final positioning result is regarded as a positioning failure and the positioning process is ended (S77).

Information indicating the final positioning result obtained as described above (information indicating the estimated position of the cellular terminal 20 or information indicating the positioning failure) is transmitted to the cellular terminal 20 or is output depending on use content. The above is another example of the positioning process (positioning method) executed by the positioning system 1 according to this embodiment.

Since GPS positioning is performed only when it is determined that the cellular terminal 20 is located outdoors in the example of the process of the flowchart shown in FIG. 18 and GPS positioning is performed only when the probability of success is high, an efficient positioning process may be implemented. On the other hand, a faster GPS positioning result may be obtained as compared to the example of FIG. 18 since the GPS positioning is performed from a start time point of the positioning process in the example of the flowchart shown in FIG. 16.

When the position of the cellular terminal 20 is estimated on the basis of a reception state of a radio wave from the cellular base station 30 for the cellular terminal 20 in the positioning system 1 according to this embodiment as described above, the position of the cellular terminal 20 is estimated after candidates for the position of the cellular terminal 20 are estimated on the basis of the availability of signal reception from the GPS satellite 40 as well as a reception state of a radio wave from the cellular base station 30. Since the availability of reception of a radio wave from the GPS satellite 40 even among wireless radio waves is likely to be clear and accurate particularly depending on an indoor position or the like, the candidate estimation by the reception availability according to this embodiment is effective. Accordingly, it is possible to obtain the highly accurate positioning result even though the position of the cellular terminal 20 is estimated from the reception state of a radio wave from the cellular base station 30 without the success of GPS positioning.

It is desirable to use a GVM corresponding to time information as in this embodiment. The position of the GPS satellite 40 varies with time and the reception availability corresponding to the position of the cellular terminal 20 varies depending on thereto. According to the above-described configuration, it is possible to appropriately estimate candidates for a position of a receiver at an arbitrary time and consequently it is possible to obtain a highly accurate positioning result at an arbitrary time.

It is desirable to control a positioning method by making an indoor/outdoor determination as in this embodiment. According to this configuration, for example, it is possible to obtain the highly accurate positioning result based on a reception state without having to actually perform the GPS positioning when determining that the cellular terminal 20 is located indoors, that is, when the possibility of a positioning failure by the GPS positioning is high. However, the position of the cellular terminal 20 may be uniformly estimated using GVMs without having to make the indoor/outdoor determination. When the GPS positioning has been actually unsuccessful, the position of the cellular terminal 20 may be estimated using GVMs.

It is desirable to decide a GVM to be used for estimating a candidate for the position of the cellular terminal 20 on the basis of the quality of reception of a signal from the GPS satellite 40 as in this embodiment. According to this configuration, it is possible to more appropriately estimate candidates for the position of the cellular terminal 20 and consequently it is possible to obtain a positioning result having a higher accuracy.

The estimation of candidates for the position of the cellular terminal 20 using GVMs, the base station positioning calculation, the indoor/output determination, the control of the positioning method, the determination of the end of the positioning process, and the like are performed by the positioning server 10 in this embodiment, but these may be all performed in the cellular terminal 20. That is, the positioning system 1 may be the cellular terminal 20 itself In contrast, the positioning system 1 may be the positioning server 10 itself. In this case, the positioning server 10 receives all information for performing a positioning calculation from the cellular terminal 20. For example, the GPS positioning calculation may be performed by the positioning server 10.

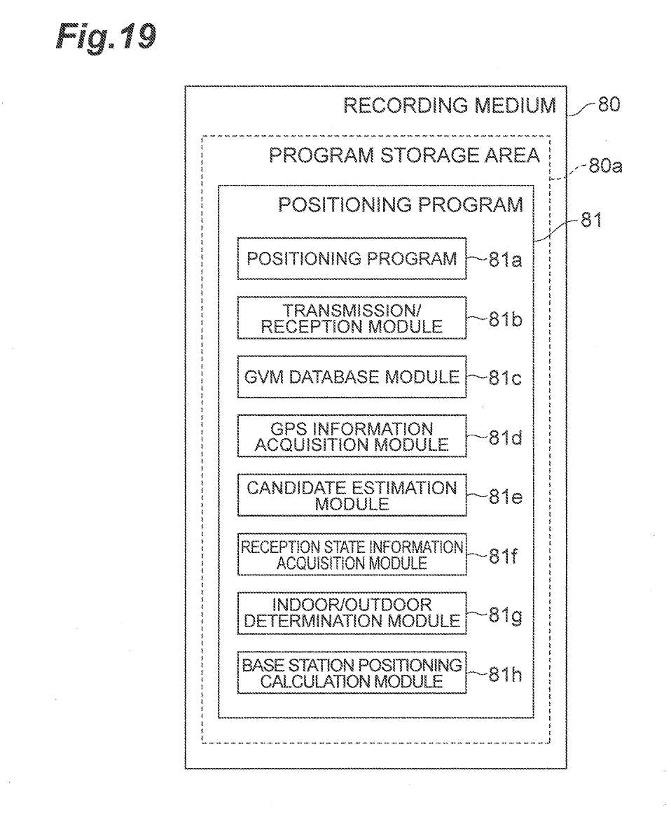

Subsequently, a positioning program for causing a computer to execute the above-described series of positioning processes of the positioning server 10 will be described. As shown in FIG. 19, a positioning program 81 is stored in a program storage area 80a formed on a recording medium 80 provided in the computer.

The positioning program 81 is constituted by including a main module 81a which generally controls the positioning process, a transmission/reception module 81b, a GVM database module 81c, a GPS information acquisition module 81d, a candidate estimation module 81e, a reception state information acquisition module 81f, an indoor/outdoor determination module 81g, and a base station positioning calculation module 81h. Functions implemented by executing the transmission/reception module 81b, the GVM database module 81c, the GPS information acquisition module 81d, the candidate estimation module 81e, the reception state information acquisition module 81f, the indoor/outdoor determination module 81g, and the base station positioning calculation module 81h are respectively the same as those of the transmission/reception component 11, the GVM database 12, the GPS information acquisition component 13, the candidate estimation component 14, the reception state information acquisition component 15, the indoor/outdoor determination component 16, and the base station positioning calculation component 17 of the above-described positioning server 10.

The positioning program 81 may be configured to be partially or totally transmitted via a transmission medium such as a communication line or the like and to be received and recorded (including installation) by other devices.

On the other hand, the following two modified examples may be adopted as an embodiment of the indoor/outdoor determination component 16. In the first modified example, the determination database 51 does not store indoor/outdoor characteristic information (the GPS availability information in the above-described embodiment) and does not make an indoor/outdoor determination based on the indoor/outdoor characteristic information. In the second modified example, an indoor/outdoor determination based on the indoor/outdoor characteristic information is not made and an indoor/outdoor determination based on the first indoor/outdoor determination method is not made. Hereinafter, the modified examples will be described in sequence.

### FIRST MODIFIED EXAMPLE

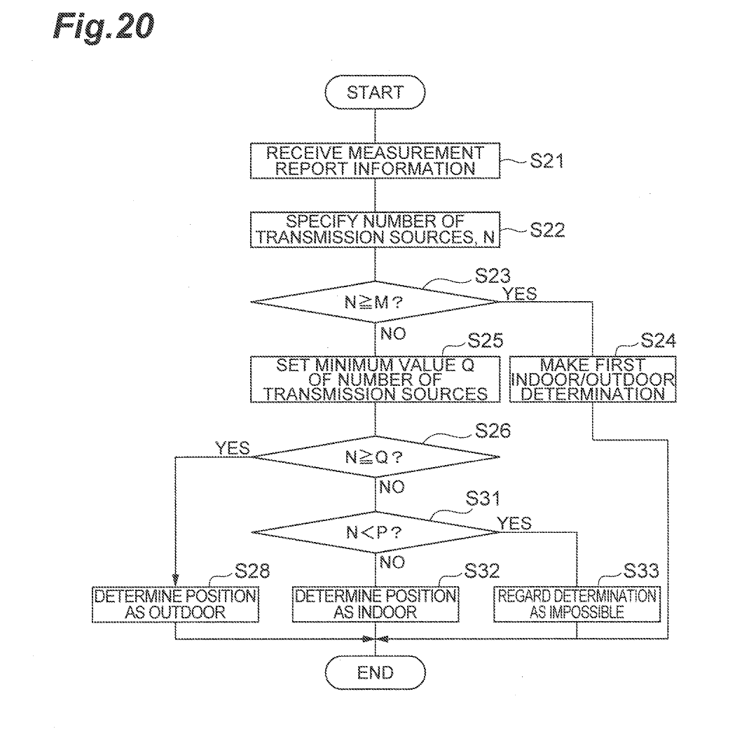

In the first modified example, the functional configuration of the indoor/outdoor determination component 16 is the same as the above-described functional configuration of FIG. 8, but the indoor/outdoor determination process (indoor/outdoor determination method) becomes the flowchart of FIG. 20. That is, in the indoor/outdoor determination process of the first modified example, first, the reception component 52 of the indoor/outdoor determination component 16 receives an MR including identification information of transmission sources of received signals from the cellular terminal 20 (S21 of FIG. 20), and the specification component 53 specifies the number of transmission sources, N, of received signals by counting the number of pieces of the identification information of transmission sources included in the received MR (S22). Next, the availability determination component 54 determines whether or not the number of transmission sources, N, is equal to or greater than the minimum number of transmission sources, M, for which the indoor/outdoor determination based on the first indoor/outdoor determination method is possible (S23).

Since it may be determined that the indoor/outdoor determination based on the first indoor/outdoor determination method is possible when the number of transmission sources, N, is equal to or greater than the minimum number of transmission sources, M, in S23, the first indoor/outdoor determination component 55 makes the indoor/outdoor determination based on the first indoor/outdoor determination method (S24).

On the other hand, since it is determined that the indoor/outdoor determination based on the first indoor/outdoor determination method is impossible when the number of transmission sources, N, is less than the minimum number of transmission sources, M, in S23, the second indoor/outdoor determination component 56 makes the indoor/outdoor determination based on a second indoor/outdoor determination method as described below. The second indoor/outdoor determination component 56 extracts combination information including all identification information of transmission sources included in an MR from the determination database 51, and sets a minimum value of the number of transmission sources included in the extracted combination information as the minimum value Q of the number of transmission sources (S25).

Next, the second indoor/outdoor determination component 56 determines whether or not the number of transmission sources, N, is equal to or greater than the minimum value Q of the number of transmission sources (S26). Since it is possible to determine that the cellular terminal 20 receives signals from transmission sources whose number is equal to or greater than the minimum number of transmission sources, M, when the number of transmission sources, N, is equal to or greater than the minimum number of transmission sources, M, in S26, it is determined that the cellular terminal 20 is located outdoors (S28).

On the other hand, when the number of transmission sources, N, is less than the minimum number of transmission sources, M, in S26, it is determined whether or not the number of transmission sources, N, is less than the minimum number of transmission sources, P, for which the indoor/outdoor determination is possible on the basis of the second indoor/outdoor determination method (S31). When the number of transmission sources, N, is less than the minimum number of transmission sources, P, it is determined that the indoor/outdoor determination based on the second indoor/outdoor determination method is impossible (S33). On the other hand, when the number of transmission sources, N, is equal to or greater than the minimum number of transmission sources, P, in step S31, it is determined that the indoor/outdoor determination is possible on the basis of the second indoor/outdoor determination method, but it is determined that the cellular terminal 20 is located indoors since it may be determined that the cellular terminal 20 does not receive signals from transmission sources whose number is equal to or greater than the minimum number of transmission sources, M, and the reception state is inferior (S32).

The indoor/outdoor determination process of FIG. 20 as described above is able to quickly obtain the determination result as to whether the cellular terminal 20 is located indoors or outdoors or whether the determination is impossible.

### SECOND MODIFIED EXAMPLE

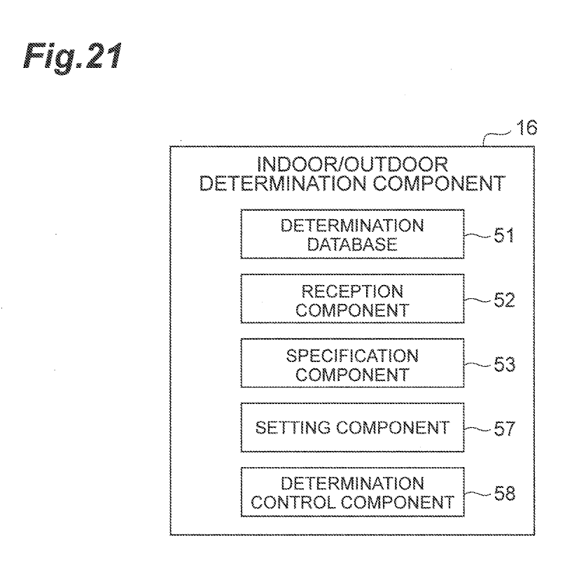

As shown in FIG. 21, the indoor/outdoor determination component 16 of the second modified example includes a setting component 57 and a determination control component 58 along with the determination database 51, the reception component 52, and the specification component 53 as in the above-described embodiment. The setting component 57 extracts combination information including all identification information of transmission sources included in an MR from the determination database 51 and sets a minimum value of the number of transmission sources included in the extracted combination information as the minimum value Q of the number of transmission sources. The determination control component 58 makes an indoor/outdoor determination by a procedure described later on the basis of the number of transmission sources, N, the minimum value Q of the number of transmission sources, and the minimum number of transmission sources, P, for which the indoor/outdoor determination is possible.

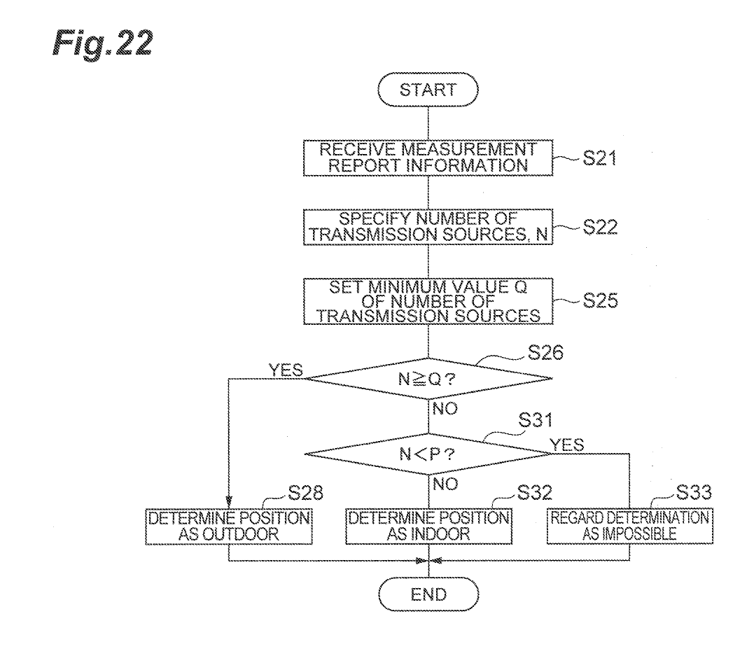

An indoor/outdoor determination process (indoor/outdoor determination method) of the second modified example becomes the flowchart of FIG. 22. That is, in the indoor/outdoor determination component 16, the reception component 52 receives an MR including information for identifying transmission sources of received signals from the cellular terminal 20 (S21 in FIG. 22), and the specification component 53 specifies the number of transmission sources, N, of received signals by counting the number of pieces of the identification information of transmission sources included in the received MR (S22). Next, the setting component 57 extracts combination information including all identification information of transmission sources included in the MR from the determination database 51 and sets a minimum value of the number of transmission sources included in the extracted combination information as the minimum value Q of the number of transmission sources (S25).

Next, the determination control component 58 determines whether or not the number of transmission sources, N, is equal to or greater than the minimum value Q of the number of transmission sources (S26). Since it is possible to determine that the cellular terminal 20 receives signals from transmission sources whose number is equal to or greater than the minimum number of transmission sources, M, when the number of transmission sources, N, is equal to or greater than the minimum number of transmission sources, M, in S26, it is determined that the cellular terminal 20 is located outdoors (S28).

On the other hand, when the number of transmission sources, N, is less than the minimum number of transmission sources, M, in S26, it is determined whether or not the number of transmission sources, N, is less than the minimum number of transmission sources, P, for which the indoor/outdoor determination is possible on the basis of the second indoor/outdoor determination method (S31). When the number of transmission sources, N, is less than the minimum number of transmission sources, P, it is determined that the indoor/outdoor determination based on the second indoor/outdoor determination method is impossible (S33). On the other hand, when the number of transmission sources, N, is equal to or greater than the minimum number of transmission sources, P, in step S31, it is determined that the indoor/outdoor determination is possible on the basis of the second indoor/outdoor determination method, but it is determined that the cellular terminal 20 is located indoors since it may be determined that the cellular terminal 20 does not receive signals from transmission sources whose number is equal to or greater than the minimum number of transmission sources, M, and the reception state is inferior (S32).

The indoor/outdoor determination process of FIG. 22 as described above is able to quickly obtain the determination result as to whether the cellular terminal 20 is located indoors or outdoors or whether the determination is impossible. The indoor/outdoor determination by the indoor/outdoor determination component 16 for the cellular terminal 20 is not necessarily limited to the above-described method, and any method may be used as long as reception state information indicating a reception state of a radio wave in the cellular terminal 20 is used.

What is claimed is:

1. A positioning system for estimating a position of a receiver having a wireless communication function and a function of receiving signals to be used for GPS positioning, comprising:
a database storing information indicating a relationship between a position and whether or not signal reception from a GPS satellite is possible in the position for each GPS satellite;
a reception GPS information acquisition unit for acquiring reception GPS information indicating GPS satellites from which the receiver has received signals;
a candidate estimation unit for estimating candidates for the position of the receiver from the reception GPS information acquired by the reception GPS information acquisition unit on the basis of the information stored in the database;
a reception state information acquisition unit for acquiring reception state information indicating a reception state of a radio wave by the wireless communication function in the receiver; and
a position estimation unit for estimating the position of the receiver from the candidates for the position of the receiver estimated by the candidate estimation unit and the reception state information acquired by the reception state information acquisition unit.

2. The positioning system according to claim 1,
wherein the database stores information indicating a relationship between a position and whether or not signal reception from a GPS satellite is possible in the position for each GPS satellite at each time,
wherein the reception GPS information acquisition unit acquires the reception GPS information and time information indicating a time when the signals have been received, and
wherein the candidate estimation unit estimates the candidates for the position of the receiver from the reception GPS information acquired by the reception GPS information acquisition unit on the basis of information stored in the database and corresponding to the time indicated by the time information acquired by the reception GPS information acquisition unit.

3. The positioning system according to claim 1, further comprising:
an indoor/outdoor determination unit for determining whether the receiver is located indoors or outdoors on the basis of the reception state information acquired by the reception state information acquisition unit,
wherein the position estimation unit estimates the position of the receiver from the candidates for the position of the receiver estimated by the candidate estimation unit and the reception state information acquired by the reception state information acquisition unit depending on the determination result by the indoor/outdoor determination unit.

4. The positioning system according to claim 1,
wherein the position estimation unit estimates the position of the receiver by the GPS positioning based on the signals received by the receiver and used for the GPS positioning, and estimates the position of the receiver from the candidates for the position of the receiver estimated by the candidate estimation unit and the reception state information acquired by the reception state information acquisition unit when the position of the receiver has not been estimated by the GPS positioning.

5. The positioning system according to claim 1,
wherein the candidate estimation unit decides the GPS satellites related to the reception GPS information to be used for estimating the candidates for the position of the receiver on the basis of the quality of reception of the signals from the GPS satellite.

6. The positioning system according to claim 1,
wherein the reception state information acquisition unit acquires strength information indicating reception strength corresponding to a transmission source of the radio wave as the reception state information, and
wherein the position estimation unit pre-stores information indicating a relationship between the reception strength of the radio wave corresponding to the transmission source of the radio wave and the position, compares the information pre-stored to the strength information acquired by the reception state information acquisition unit, and estimates the position of the receiver from the comparison result and the candidates for the position of the receiver estimated by the candidate estimation unit.

7. The positioning system according to claim 1,
wherein the position estimation unit calculates a distance between the transmission source of the radio wave and the receiver on the basis of the reception state information, and estimates the position of the receiver from the distance and the candidates for the position of the receiver estimated by the candidate estimation unit.

8. A positioning method for use in a positioning system for estimating a position of a receiver having a wireless communication function and a function of receiving signals to be used for GPS positioning, wherein the positioning system has a database storing information indicating a relationship between a position and whether or not signal reception from a GPS satellite is possible in the position for each GPS satellite, the positioning method comprising;
a reception GPS information acquisition step of acquiring reception GPS information indicating GPS satellites from which the receiver has received signals;
a candidate estimation step of estimating candidates for the position of the receiver from the reception GPS information acquired in the reception GPS information acquisition step on the basis of the information stored in the database;
a reception state information acquisition step of acquiring reception state information indicating a reception state of a radio wave by the wireless communication function in the receiver; and
a position estimation step of estimating the position of the receiver from the candidates for the position of the receiver estimated in the candidate estimation step and the reception state information acquired in the reception state information acquisition step.

9. A positioning program for causing a computer to estimate a position of a receiver having a wireless communication function and a function of receiving signals to be used for GPS positioning, the positioning program causing the computer to execute:
a database function of storing information indicating a relationship between a position and whether or not signal reception from a GPS satellite is possible in the position for each GPS satellite;
a reception GPS information acquisition function of acquiring reception GPS information indicating GPS satellites from which the receiver has received signals;
a candidate estimation function of estimating candidates for the position of the receiver from the reception GPS information acquired by the reception GPS information acquisition function on the basis of the information stored in the database;
a reception state information acquisition function of acquiring reception state information indicating a reception state of a radio wave by the wireless communication function in the receiver; and
a position estimation function of estimating the position of the receiver from the candidates for the position of the receiver estimated by the candidate estimation function and the reception state information acquired by the reception state information acquisition function.
